(19) United States
(12) Patent Application Publication
(10) Pub. No.: US 2012/0130558 A1
(43) Pub. Date: May 24, 2012

(54) ELECTRIC-POWER TRANSACTION APPARATUS AND METHOD OF CONTROLLING ELECTRIC-POWER TRANSACTION APPARATUS

(75) Inventor: Yasuo Yoshimura, Shiga (JP)

(73) Assignee: PANASONIC CORPORATION, Osaka (JP)

(21) Appl. No.: 13/387,891

(22) PCT Filed: Feb. 10, 2011
(86) PCT No.: PCT/JP2011/000748

§ 371 Date: Jan. 30, 2012

(30) Foreign Application Priority Data
Feb. 12, 2010 (JP) 2010-029410

(51) Int. Cl. G06F 1/28

(52) U.S. Cl. 700/297

(57) ABSTRACT

An electric power information control unit compares electric power value information relating to a specific electric power amount of an electric power amount of a first storage battery and electric power value information relating to the specific electric power amount of the electric power amount of the second storage battery. When there are electric power information in which the electric power value information relating to the specific electric power amount are different from each other in the first and second storage batteries, the electric power information control unit swaps and stores the electric power value information in the first electric power information storing unit and the second electric power information storing unit.

### TECHNICAL FIELD

The present invention relates to an electric-power transaction apparatus which performs electric power transaction between electric powers that are different in value, and a control method thereof. For example, the present invention relates to an electric-power transaction apparatus which performs electric power transaction between electric power generated from natural energy such as solar energy or wind energy and electric power generated from fossil fuels such as petroleum or gas, and a control method thereof.

### BACKGROUND ART

In recent years, an attempt has been made to develop a purchasing system for electric power generated in a solar power generation apparatus to rapidly spread solar power generation apparatuses. The Japanese government raised the purchasing price to two times the previous price from November, 2009 (48 yen per kilowatt-hour in general houses).

On the other hand, electric power generated from fossil fuels such as petroleum or coal is not a purchasing target. Further, in a case where the solar power generation apparatus is installed on agricultural land, even though agricultural land is suitable for a wide range of power generation with good sunlight conditions and quite a wide area, electric power generated on agricultural land is excluded from the purchasing target. Thus, in spite of the same electric power in appearance, the electric power is handled differently in electric power purchasing according to the generation method or the like, which results in high value electric power and low value electric power.

In the related art, for example, techniques disclosed in Patent Document 1 and Patent Document 2 are known as techniques relating to electric power exchange.

Patent Document 1 discloses an electric power information processing method in which an installer side which has power generation means and a manager side which manages electric power information are connected through a network, the installer side measures the amount of electric power generated in the power generation means and the amount of electric power consumed by the installer themselves and notifies the manager side of each item of electric power history information, and the manager side calculates a valid-selling generated power amount which can be validly sold by the installer from the electric power history information transmitted from the installer and calculates a price corresponding to the valid-selling generated power amount.

Patent Document 2 discloses an electric power load leveling method in which electric power stored in a battery is discharged at a peak time for electric power demand in a business location, which is an electric power consumer supplied with electricity from an electric power company, so as to level electric power load, and in which each battery of a plurality of automobiles is charged at a non-peak time for the electric power demand in the business location or using night power for individually owned automobiles and the electric power stored in the charged battery of the automobile is discharged at the peak time for the power demand in the business location.

### RELATED ART DOCUMENTS

### Patent Documents

Patent Document 1: JP-A-2005-185016
Patent Document 2: JP-A-2007-282383

### SUMMARY OF THE INVENTION

### Problem to be Solved by the Invention

By the way, in a case where a power generating party (for example, a person having a solar power generation apparatus in a general house) has both high value electric power (electric power generated in the solar power generation apparatus) and low value electric power (electric power generated from fossil fuels such as petroleum or coal), the power generating party may preferentially consume the low value electric power and may sell the high value electric power to a different party to utilize its value. However, if the low value electric power is used up, the power generating party has to use the high value electric power.

It is preferable that solar power generation apparatuses be widely spread in houses so that people who know the importance of electric power transaction of renewable energy, for example, through a green electricity certificate can efficiently use electric power generated therefrom, but this is not yet satisfactory.

An object of the present invention is to provide an electric-power transaction apparatus and a control method thereof which can perform electric power transaction with high reliability between a person who desires to sell high value electric power and a person using low value electric power who desires to obtain high value electric power.

### Means for Solving the Problem

According to an aspect of the invention, there is provided an electric-power transaction apparatus including: first electric power information obtaining means for obtaining information from first electric power information storing means configured to store first electric power information including an amount of electric power stored in a first storage battery and electric power value information which is information relating to a value of the electric power amount; second electric power information obtaining means for obtaining information from second electric power information storing means configured to store second electric power information including an amount of electric power stored in a second storage battery and electric power value information of the electric power amount; and electric power information control means for performing electric power transaction between the first storage battery and the second storage battery based on the first electric power information and the second electric power information, wherein the electric power information control means compares the electric power value information relating to a specific electric power amount of the electric power amount of the first storage battery and the electric power value information relating to the specific electric power amount of the electric power amount of the second storage battery, and swaps and stores, when there are the electric power information in which the electric power value information relating to the specific electric power amount are different from each other in both the storage batteries, the electric power value information in the first electric power information storing means and the second electric power information storing means.

According to this configuration, as the electric power value information relating to the values of the electric power stored in the respective first storage battery and second storage battery are compared with each other, and the pieces of electric power value information are swapped and stored when the pieces of electric power information in which the pieces of electric power value information in the specific electric power amount are different from each other are present in both the storage batteries, it is possible to perform electric power transaction with high reliability between a person who desires to sell high value electric power and a person using low value electric power who desires to obtain high value electric power.

In the above configuration, the electric power value information may include a power generation method or an electric power price for the amount of electric power stored in each of the storage batteries.

According to this configuration, by using the electric power value information including the power generation method or the electric power price for the amount of electric power stored in each storage battery, it is possible to accurately detect the high value electric power and the low value electric power, and to perform electric power transaction with high reliability.

In the above configuration, the electric power information control means may divide the first electric power information into a plurality of pieces of electric power information to compare the electric power value information relating to the specific electric power amount between the electric power amount of the first storage battery and the electric power amount of the second storage battery.

According to this configuration, by dividing the first electric power information into the plurality of pieces of electric power information, it is easy to compare the pieces of electric power value information in the specific electric power amount, and to perform electric power transaction with high reliability.

In the above configuration, the electric-power transaction apparatus may further include storage state detecting means for detecting a storage state of the first storage battery, and the electric power information control means may compare, when the storage state detecting means determines that the discharging speed of the first storage battery is a predetermined value or lower, the electric power value information relating to the specific electric power amount.

According to this configuration, by monitoring the discharging speed, it is possible to prevent the electric power transaction from being performed while the first storage battery is being discharged (that is, while the electric power is being used), and to perform electric power transaction with high reliability.

In the above configuration, the electric power information control means may re-measure the amount of electric power stored in the first storage battery by the storage state detecting means before comparing the electric power value information relating to the specific electric power amount, and update and store the first electric power information in the first electric power information storing means.

According to this configuration, by re-measuring the amount of electric power stored in the first storage battery and by updating the first electric power information before comparing the pieces of electric power value information in the specific electric power amount, it is possible to perform electric power transaction with high reliability.

In the above configuration, the electric-power transaction apparatus may further include: storage battery characteristic correcting means in which the storage characteristics of the first storage battery are stored, and the electric power information control means may correct the amount of electric power stored in the first storage battery by the storage battery characteristic correcting means before comparing the electric power value information relating to the specific electric power amount, and update the first electric power information to perform the electric power transaction.

According to this configuration, by correcting the amount of electric power stored in the first storage battery and by updating the first electric power information before comparing the pieces of electric power value information in the specific electric power amount, it is possible to perform electric power transaction with high reliability.

In the above configuration, the first electric power information may include information relating to a temperature of the first storage battery measured when the amount of electric power stored in the first storage battery is measured, and the storage battery characteristic correcting means may include temperature characteristics correcting means in which characteristics of the storage amount and temperature of the first storage battery are stored. Further, the electric power information control means may correct the amount of electric power stored in the first storage battery based on the measured temperature and temperature at the electric power transaction by the temperature characteristics correcting means before comparing the electric power value information relating to the specific electric power amount, and updates the first electric power information to perform the electric power transaction.

According to this configuration, by correcting the amount of electric power stored in the first storage battery from the measured temperature obtained by measuring the temperature of the first storage battery and the temperature when the electric power transaction is performed and by updating the first electric power information before comparing the pieces of electric power value information in the specific electric power amount, it is possible to perform electric power transaction with high reliability.

In the above configuration, the first electric power information may include information relating to a time measured when the amount of electric power stored in the first storage battery is measured, and the storage battery characteristic correcting means may include self-discharging characteristic correcting means in which characteristics of the storage amount and elapsed time of the first storage battery are stored. Further, the electric power information control means may correct the amount of electric power stored in the first storage battery based on the measured time and a time at the electric power transaction by the self-discharging characteristic correcting means before comparing the electric power value information relating to the specific electric power amount, and updates the first electric power information to perform the electric power transaction.

According to this configuration, by correcting the amount of electric power stored in the first storage battery from the measured time and the time when the electric power transaction is performed and by updating the first electric power information before comparing the pieces of electric power value information in the specific electric power amount, it is possible to perform electric power transaction with high reliability.

According to another aspect of the invention, there is provided a method of controlling an electric-power transaction apparatus, the method including: a first electric power information obtaining step of obtaining information from first electric power information storing means configured to store first electric power information including an amount of electric power stored in a first storage battery and electric power value information which is information relating to a value of the electric power amount; a second electric power information obtaining step of obtaining information from second electric power information storing means configured to store second electric power information including an amount of electric power stored in a second storage battery and electric power value information of the electric power amount; and an electric power transaction step of performing electric power transaction between the first storage battery and the second storage battery based on the first electric power information and the second electric power information, wherein the electric power transaction step includes comparing the electric power value information relating to a specific electric power amount of the electric power amount of the first storage battery and the electric power value information relating to the specific electric power amount of the electric power amount of the second storage battery, and swapping and storing, when there are the electric power information in which the electric power value information in the specific electric power amount are different from each other in both the storage batteries, the electric power value information in the first electric power information storing means and the second electric power information storing means.

According to this method, as the pieces of electric power value information relating to the values of the electric power stored in the respective first storage battery and second storage battery are compared with each other, and the pieces of electric power value information are swapped and stored when the pieces of electric power information in which the pieces of electric power value information in the specific electric power amount are different from each other are present in both the storage batteries, it is possible to perform electric power transaction with high reliability between a person who desires to sell high value electric power and a person using low value electric power who desires to obtain high value electric power.

According to yet another aspect of the invention, there is provided a program which causes the control method of the electric-power transaction apparatus to be executed on the computer.

According to this program, as the pieces of electric power value information relating to the values of the electric power stored in the respective first storage battery and second storage battery are compared with each other, and the pieces of electric power value information are swapped and stored when the pieces of electric power information in which the pieces of electric power value information in the specific electric power amount are different from each other are present in both the storage batteries, it is possible to perform electric power transaction with high reliability between a person who desires to sell high value electric power and a person using low value electric power who desires to obtain high value electric power.

### Advantages of the Invention

According to the invention, it is possible to perform electric power transaction with high reliability between a person who desires to sell high value electric power and a person using low value electric power who desires to obtain high value electric power.

### BRIEF DESCRIPTION OF THE DRAWINGS

FIG. 1 is a block diagram schematically illustrating a configuration of an electric-power transaction apparatus according to a first embodiment of the present invention.

FIG. 2 is a diagram schematically illustrating an outline of electric power transaction through an electric vehicle using the electric-power transaction apparatus in FIG. 1.

FIGS. 3(a) and 3(b) are pattern diagrams illustrating the flow of electric power transaction using the electric-power transaction apparatus in FIG. 1.

FIG. 4 is a diagram illustrating an example of electric power information stored in a first electric power information storage unit of a first electric-power transaction apparatus in FIG. 1.

FIG. 5 is a diagram illustrating an example of electric power information stored in a second electric power information storage unit of a second electric-power transaction apparatus in FIG. 1.

FIG. 6 is a flowchart illustrating operations of the first and second electric-power transaction apparatuses in FIG. 1.

FIG. 7 is a block diagram schematically illustrating a configuration of an electric-power transaction apparatus according to a second embodiment of the present invention.

FIG. 8 is a diagram illustrating an example of electric power information stored in a first electric power information storage unit of a first electric-power transaction apparatus in FIG. 7.

FIG. 9 is a diagram illustrating an example of electric power information stored in a second electric power information storage unit of a second electric-power transaction apparatus in FIG. 7.

FIG. 10 is a flowchart illustrating operations of the first and second electric-power transaction apparatuses in FIG. 7.

FIG. 11 is a block diagram schematically illustrating a configuration of an electric-power transaction apparatus according to a third embodiment of the present invention.

FIG. 12 is a diagram schematically illustrating an outline of electric power transaction through an information communication network using the electric-power transaction apparatus in FIG. 11.

FIG. 13 is a flowchart illustrating operations of first and second electric-power transaction apparatuses in FIG. 11.

FIG. 14 is a block diagram schematically illustrating a configuration of an electric-power transaction apparatus according to a fourth embodiment of the present invention.

FIG. 15 is a flowchart illustrating operations of first and second electric-power transaction apparatuses in FIG. 14.

### MODE FOR CARRYING OUT THE INVENTION

Hereinafter, preferred embodiments of the present invention will be described in detail with reference to the accompanying drawings.

### First Embodiment

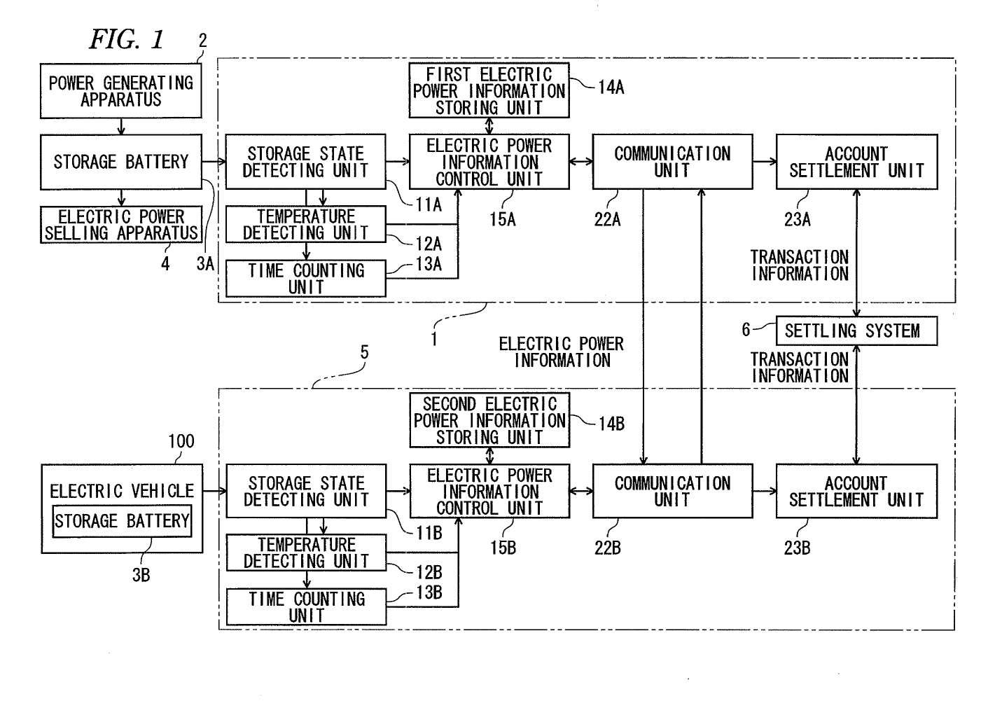

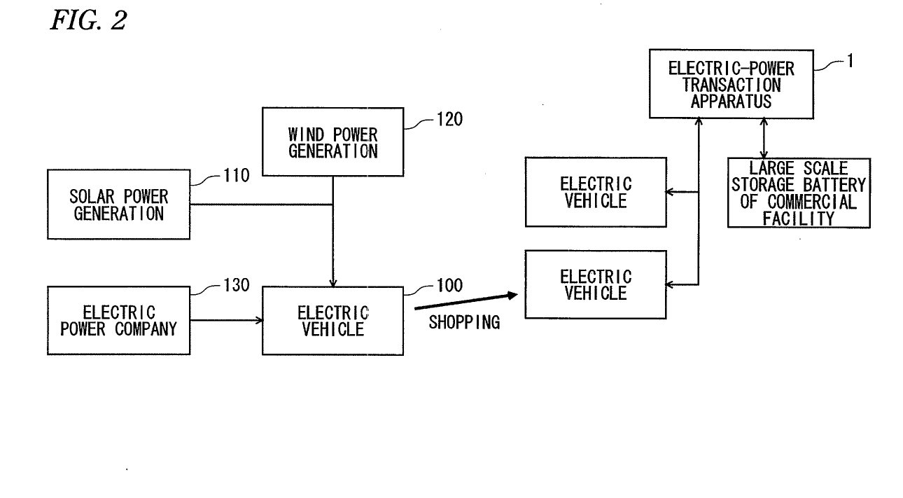

FIG. 1 is a block diagram schematically illustrating a configuration of an electric-power transaction apparatus according to a first embodiment of the present invention. A first electric-power transaction apparatus 1 and a second electric-power transaction apparatus 5 shown in FIG. 1 have the same configuration and function. FIG. 2 is a diagram schematically illustrating an outline of electric power transaction through an electric vehicle using the electric-power transaction apparatus according to the present embodiment. In FIG. 2, the first electric-power transaction apparatus 1 of the first electric-power transaction apparatus 1 and the second electric-power transaction apparatus 5 shown in FIG. 1 is installed in a commercial facility, and the second electric-power transaction apparatus 5 is installed in an electric vehicle 100.

As shown in FIG. 2, in the electric vehicle 100, a storage battery 3B (see FIG. 1, second storage battery) is charged with high value electric power obtained by a solar power generation 110 or a wind power generation 120, or is charged with low value electric power from an electric power company 130. When go shopping using the electric vehicle 100, a user sells high value electric power by connecting the electric vehicle 100 to the first electric-power transaction apparatus 1 which is installed in the commercial facility. Further, if necessary, the user purchases low value electric power from the first electric-power transaction apparatus 1. The electric vehicle 100 stores at least electric power necessary for going to a charging station from the commercial facility and returning to the commercial facility, in the storage battery 3B.

The low value electric power and the high value electric power are mixed in the storage battery 3B of the electric vehicle 100 in this way, and the high value electric power is to be sold to the commercial facility. Here, in the present invention, electric power transaction is not performed by charging and discharging, but is performed by replacement of numerical values or data. That is, since the high value electric power and the low value electric power are the same electric power, it is not necessary to perform exchange through charging and discharging during transaction, and the transacted numerical values or data may be rewritten. Additionally, if the charging and discharging are performed during transaction, the process takes time, and, although only a small amount, electric power is lost due to electric resistance or contact resistance of the track, or the storage battery is deteriorated due to an increase in the number of charge and discharge cycles, which is not preferable.

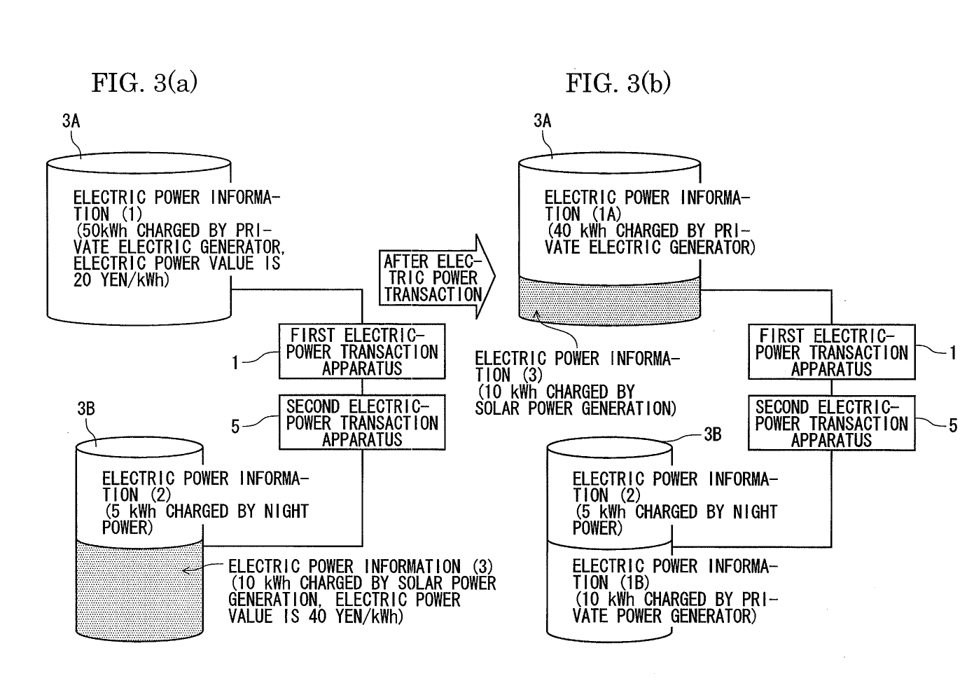

FIG. 3 is a diagram schematically illustrating the flow of electric power transaction using the first electric-power transaction apparatus 1 and the second electric-power transaction apparatus 5 shown in FIG. 1, in which (a) shows charging states of a storage battery (first storage battery) 3A and a storage battery 3B before electric power selling and (b) shows charging states of the storage battery 3A and the storage battery 3B after electric power selling. In the storage battery 3A on the side of the first electric-power transaction apparatus 1, for example, 50 kWh of electric power which is charged with a private electric generator is stored. The value of the electric power charged with the private electric generator is 20 Yen/kWh, for example (low value electric power). A first piece of electric power information including the electric power amount of the storage battery 3A and electric power value information which is information relating to the value of the electric power amount is stored in a first electric power information storage unit 14A.

On the other hand, in the storage battery 3B on the side of the second electric-power transaction apparatus 5, for example, an electric power of 5 kWh which is charged with night power and 10 kWh of electric power which is charged with the solar power generation are stored. The value of the electric power which is charged with the solar power generation is 40 Yen/kWh, for example (high value electric power). A second piece of electric power information including the electric power amount of 5 kWh, the electric power amount of 10 kWh and electric power value information which is information relating to the values of these electric power amounts is stored in a second electric power information storage unit 14B.

In a case where electric power transaction is performed between the first electric-power transaction apparatus 1 and the second electric-power transaction apparatus 5, since the 10 kWh of electric power which is stored in the storage battery 3B on the side of the second electric-power transaction apparatus 5 is the high value electric power, this is sold to the side of the first electric-power transaction apparatus 1. In the cases of (a) and (b) of FIG. 3, the entire 10 kWh of electric power is sold in the second electric-power transaction apparatus 5. On the other hand, since the 50 kWh of electric power which is stored in the storage battery 3A on the side of the first electric-power transaction apparatus 1 is the low value electric power, this is sold to the side of the second electric-power transaction apparatus 5. At this time, the 10 kWh of electric power is sold in the second electric-power transaction apparatus 5.

The electric power transaction is not performed by charging and discharging as described above, but is performed only by replacement of the numerical values or data. In the present embodiment, an “electric power label is used for the electric power transaction. For example, in the cases of (a) and (b) of FIG. 3, each of “electric power information (1)”, “electric power information (1A)”, “electric power information (2)”, “electric power information (3)”, and “electric power information (1B)” is the electric power label. After the electric power transaction, as shown in (b) of FIG. 3, the storage state of the storage battery 3A on the side of the first electric-power transaction apparatus 1 becomes 40 kWh which is charged with the private electric generator and 10 kWh which is purchased from the electric vehicle 100, and the storage state of the storage battery 3B on the side of the second electric-power transaction apparatus 5 becomes 5 kWh which is charged with the night power and 10 kWh which is purchased from the side of the first electric-power transaction apparatus 1.

Next, the first electric-power transaction apparatus 1 and the second electric-power transaction apparatus 5 will be described in detail. In FIG. 1, the first electric-power transaction apparatus 1 includes a storage state detecting unit 11A, a temperature detecting unit 12A, a time counting unit 13A, the first electric power information storage unit 14A, an electric power information control unit 15A, a communication unit 22A, and an account settlement unit 23A. The storage battery 3A is connected to the first electric-power transaction apparatus 1, and the storage battery 3A stores electric power generated by a power generating apparatus 2. Further, an electric power selling apparatus 4 through which the electric power is sold in practice is connected to the storage battery 3A.

In the first electric-power transaction apparatus 1, the storage state detecting unit 11A detects a storage state such as a charging or discharging speed of the storage battery 3A, and notifies the electric power information control unit 15A of the result. The temperature detecting unit 12A detects a peripheral temperature of the storage battery 3A when the storage state detecting unit 11A detects the storage state of the storage battery 3A, and notifies the electric power information control unit 15A of the result. The time counting unit 13A notifies the electric power information control unit 15A of time information when the temperature detecting unit 12A detects the peripheral temperature of the storage battery 3A.

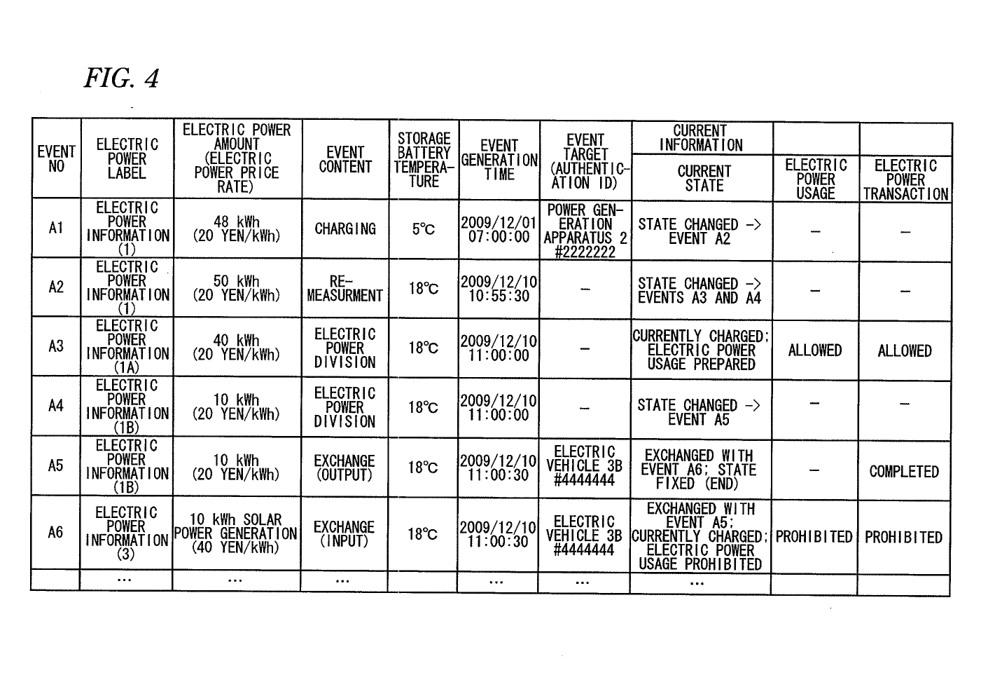

The first electric power information storage unit 14A stores the electric power information relating to the storage battery 3A, that is, the first electric power information. Although described in detail later, the first electric power information storage unit 14A stores the electric power information as shown in FIG. 4. The electric power information control unit 15A includes first electric power information obtaining means and second electric power information obtaining means, and performs the process of electric power transaction between the storage battery 3A on the side of the first electric-power transaction apparatus 1 and the storage battery 3B on the side of the second electric-power transaction apparatus 5, on the basis of the first electric power information stored in the first electric power information storage unit 14A which is obtained by the first electric power information obtaining means and the second electric power information stored in the second electric power information storage unit 14B which is obtained by the second electric power information obtaining means from the second electric-power transaction apparatus 5 through the communication unit 22A. Specifically, between the electric power amount of the storage battery 3A and the electric power amount of the storage battery 3B, the pieces of electric power value information in a specific electric power amount are compared, when the pieces of electric power information having different electric power value information in the specific electric power amount are present in the storage batteries 3A and 3B, the pieces of electric power value information are swapped and stored in the first electric power information storage unit 14A and the second electric power information storage unit 14B of the second electric-power transaction apparatus 5. The electric power value information is information including a power generating method of the amounts of the electric power stored in the storage batteries 3A and 3B or electric power values thereof. Here, the specific electric power amount which is the amount of electric power transaction has a small electric power amount when the pieces of electric power information having different electric power value information are compared with each other, as a maximum value.

The electric power information control unit 15A is configured by a microprocessor, for example, and divides the first electric power information stored in the first electric power information storage unit 14A into a plurality of pieces of electric power information, in order to compare the pieces of electric power value information in the specific electric power amount, between the electric power amount of the storage battery 3A and the electric power amount of the storage battery 3B, in the electric power transaction process. Further, the electric power information control unit 15A compares the pieces of electric power value information in the specific electric power, when the discharging speed of the storage battery 3A is a predetermined value or lower by the storage state detecting unit 11A. Here, the reason why it is confirmed that the discharging speed of the storage battery 3A is the predetermined value or lower is to restrict electric power transaction during discharging of the storage battery 3A when the electric power is decreasing (while the electric power is being used). Thus, it is possible to enhance the reliability in the electric power transaction.

That is, since the electric power stored in the storage battery 3A decreases during discharging, when the discharging speed is high, electric power transaction is not performed so that electric power larger than the stored electric power is not transacted in the first electric-power transaction apparatus 1. If the discharging speed is sufficiently slower than the speed of electric power transaction, electric power transaction can be performed. Further, the electric power stored in the storage battery 3A is increased during charging, and thus, the electric power larger than the stored electric power is not transacted in the first electric-power transaction apparatus 1 as described above. Here, the electric power transaction in the first electric-power transaction apparatus 1 may not be performed while the storage battery 3A is being charged or discharged.

Further, before the pieces of electric power value information in the specific electric power amount are compared, the electric power information control unit 15A re-measures the amount of electric power stored in the storage battery 3A using the storage state detecting unit 11A, and updates the first electric power information stored in the first electric power information storage unit 14A and stores the result in the first electric power information storage unit 14A. Since the amount of electric power stored in the storage battery 3A is re-measured and the first electric power information is updated before the pieces of electric power value information in the specific electric power amount are compared, it is possible to perform electric power transaction with high reliability in consideration of self-discharging of the storage battery 3A.

Returning to FIG. 1, the communication unit 22A transmits the first electric power information stored in the first electric power information storage unit 14A to the second electric-power transaction apparatus 5, and obtains the second electric power information relating to the storage battery 3B of the electric vehicle 100 from the second electric-power transaction apparatus 5. The account settlement unit 23A transmits prices of the electric power exchanged between the first electric-power transaction apparatus 1 and the second electric-power transaction apparatus 5 to a settling system 6 to perform price settlement.

In a similar manner to the first electric-power transaction apparatus 1, the second electric-power transaction apparatus 5 includes a storage state detecting unit 11B, a temperature detecting unit 12B, a time counting unit 13B, the second electric power information storage unit 14B, an electric power information control unit 15B, a communication unit 22B, and an account settlement unit 23B. The storage state detecting unit 11B detects a storage state such as the discharging speed of the storage battery 3B (second storage battery) of the electric vehicle 100, and notifies the electric power information control unit 15B of the result. The temperature detecting unit 12B detects a peripheral temperature of the storage battery 3B when the storage state detecting unit 11B detects the storage state of the storage battery 3B, and notifies the electric power information control unit 15B of the result. The time counting unit 13B notifies the electric power information control unit 15B of time information when the temperature detecting unit 12B detects the peripheral temperature of the storage battery 3B.

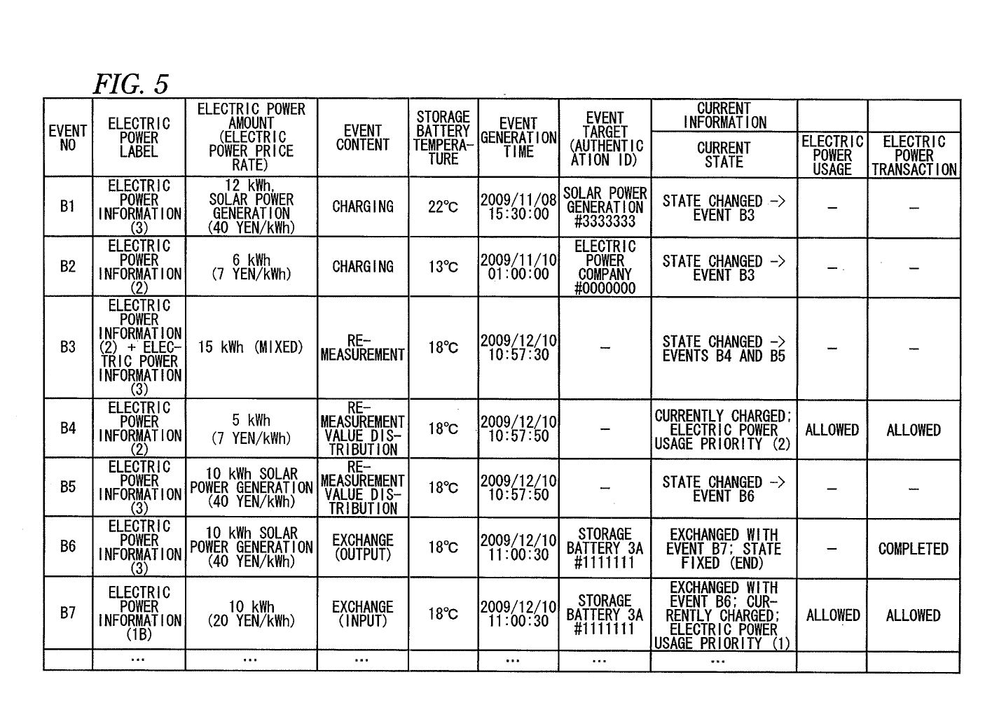

The second electric power information storage unit 14B stores electric power information relating to the storage battery 3B, that is, the second electric power information. Although described in detail later, the second electric power information storage unit 14B stores electric power information as shown in FIG. 5. The electric power information control unit 15B communicates the electric power information with the first electric-power transaction apparatus 1 through the communication unit 22B, and performs the electric power transaction between the storage battery 3B and the storage battery 3A using the information and a variety of pieces of information obtained by the storage state detecting unit 11B, the temperature detecting unit 12B and the time counting unit 13B.

The electric power information control unit 15B includes first electric power information obtaining means and second electric power information obtaining means, and performs the process of electric power transaction between the storage battery 3B on the side of the second electric-power transaction apparatus 5 and the storage battery 3A on the side of the first electric-power transaction apparatus 1, on the basis of the second electric power information stored in the second electric power information storage unit 14B which is obtained by the second electric power information obtaining means and the first electric power information stored in the first electric power information storage unit 14A which is obtained by the first electric power information obtaining means from the first electric-power transaction apparatus 1 through the communication unit 22A. Specifically, the pieces of electric power value information in a specific electric power amount are compared between the electric power amount of the storage battery 3B and the electric power amount of the storage battery 3A, and when the pieces of electric power information having different electric power value information in the specific electric power amount are present in the storage batteries 3B and 3A, the pieces of electric power value information are swapped and stored in the second electric power information storage unit 14B and the first electric power information storage unit 14A of the first electric-power transaction apparatus 1. The electric power value information is information including a power generating method of the amounts of the electric power stored in the storage batteries 3B and 3A or electric power values thereof.

Here, the electric power information control unit 15B divides the second electric power information stored in the second electric power information storage unit 14B into a plurality of pieces of electric power information, in order to compare the pieces of electric power value information in the specific electric power amount, between the electric power amount of the storage battery 3B and the electric power amount of the storage battery 3A, in the electric power transaction process. Further, the electric power information control unit 15B, when the discharging speed of the storage battery 3B is a predetermined value or lower, compares the pieces of electric power value information in the specific electric power using the storage state detecting unit 11B. Further, before the pieces of electric power value information in the specific electric power amount are compared, the electric power information control unit 15B re-measures the amount of electric power stored in the storage battery 3B using the storage state detecting unit 11B, and updates the second electric power information stored in the second electric power information storage unit 14B and stores the result in the second electric power information storage unit 14B.

Returning to FIG. 1, the communication unit 22B transmits the second electric power information stored in the second electric power information storage unit 14B to the first electric-power transaction apparatus 1, and obtains the first electric power information relating to the storage battery 3A from the first electric-power transaction apparatus 1. The account settlement unit 23B transmits prices of the electric power exchanged between the first electric-power transaction apparatus 1 and the second electric-power transaction apparatus 5 to the settling system 6 to perform price settlement.

FIG. 4 is a diagram illustrating an example of the first electric power information stored in the first electric power information storage unit 14A of the first electric-power transaction apparatus 1. The first electric power information includes “event No.”, “electric power label”, “electric power amount (electric power price rate)”, “event content”, “storage battery temperature”, “event occurrence time”, “event target”, and “current information (current state, electric power usage and electric power transaction). For example, in the case of an event No. A1, the “electric power label” is electric power information (1), the “electric power amount (electric power price rate)” is 48 kWh (20 Yen/kWh), and the “event content” is charging, the “storage battery temperature” is 5 degrees, the “event occurrence time” is Jan. 12, 2009 07:00:00, the “event target” is the power generating apparatus 2 #2222222, and the “current state of the current information” is “state changed→event A2”.

In FIG. 4, events caused by the first electric power information are given event Nos., a history including a past history is displayed, but a format may be used in which only the latest events are shown. For example, only A3 and A6 which are the latest events may be displayed.

In the “current information”, the “electric power usage” is a setting about whether the electric power of the storage battery 3A is discharged for use. For example, while the electric-power transaction apparatus 1 is transacting the electric power of the storage battery 3A, the “electric power usage” is set to “prohibited” so that the electric power of the storage battery 3A is not used. Further, the “electric power transaction” is a setting about whether the electric power of the storage battery 3A can be transacted in the first electric-power transaction apparatus 1. As described above, when the discharging speed is the predetermined value or higher or while the electric power is being used (actually used), the “electric power transaction” is set to “prohibited” so that electric power transaction is not allowed. Further, the obtained high value electric power may be set to “prohibited” so that the electric power usage or the electric power transaction is not allowed, to thereby maintain the obtained high value electric power.

The “electric power amount” is a value measured by the storage state detecting unit 11A, and the “event content” is an event which is performed by the electric power information control unit 15A. The “storage battery temperature” is a value measured by the temperature detecting unit 12A, and the “event occurrence time” is a value measured by the time counting unit 13A. The “event target” is the value of an authentication ID which is obtained by the communication unit 22A. The “event information” is managed by the electric power information control unit 15A.

In the example shown in FIG. 4, the electric power information (1) is divided into (1A) and (1B) to be exchanged with the electric power information (3). That is, the electric power information control unit 15A divides the first electric power information into a plurality of pieces of electric power information, in order to compare the pieces of electric power value information in the specific electric power amount, between the electric power amount of the storage battery 3A and the electric power amount of the storage battery 3B. For example, as shown in FIG. 4, the electric power information control unit 15A re-measures the amount of electric power stored in the storage battery 3A in the event A2 before division.

For example, in the event A1, there is an electric power of 48 kWh which is charged from the power generating apparatus 2 at a storage battery temperature of 5 degrees, at 7 am, Dec. 1, 2009. When being re-measured, in the event A2, the electric power is changed to 50 kWh at a storage battery temperature of 18 degrees, at 10:55:30, Dec. 10, 2009. In this way, the electric power amount extracted from the storage battery is changed due to the difference between temperatures of the storage batteries or the influence of the self-discharging of the storage battery.

Next, the re-measured electric power amount is divided. In the events A3 and A4, the electric power information (1) of 50 kWh is divided into the electric power information (1A) and the electric power information (1B) to create the electric power information (1B) of 10 kWh which is the same as the electric power information (3).

Further, in events A5 and A6, the electric power transaction is performed with the electric power information (1B) stored in the storage battery 3A and the electric power information (3) stored in the storage battery 3B. Since the electric power information (1B) in the event A5 is transacted with the electric power information (3), the information about “electric power transaction” in the “current information” of the event A5 is “completed”, and the electric power transaction completion is displayed.

Further, since the electric power information (3) of the event A6 is the high value electric power (40 Yen/kWh) obtained by exchange with the electric power information (1B), the “electric power usage” and the “electric power transaction” in the “current information” of the event A6 are set to “prohibited” to thereby maintain a state where the electric power usage and the electric power transaction are not allowed.

FIG. 5 is a diagram illustrating an example of the second electric power information stored in the second electric power information storage unit 14B of the second electric-power transaction apparatus 5. The second electric power information includes “event No.”, “electric power label”, “electric power amount (electric power price rate)”, “event content”, “storage battery temperature”, “event occurrence time”, “event target”, and “current information (current state, electric power usage and electric power transaction), in a similar way to the electric power information stored in the first electric power information storage unit 14A of the first electric-power transaction apparatus 1 as described above. In the “current state” among the “current information”, if a plurality of allowances for electric power usage is present, its usage priority is determined by the electric power information control unit 15B. Here, in events B4 and B7, the electric power information (1B) in which the electric power price rate is low is set to be used prior to the electric power information (2).

The electric power information control unit 15B divides the second electric power information into a plurality of pieces of electric power information, in order to compare the pieces of electric power value information in the specific electric power amount, between the electric power amount of the storage battery 3B and the electric power amount of the storage battery 3A. In the event B3, the electric power information control unit 15B re-measures the amount of electric power stored in the storage battery 3B before division.

The electric power stored in the storage battery 3B includes 12 kWh of electric power which is charged from the solar power generating apparatus at a storage temperature of 22 degrees, at 3:30 pm, Nov. 8, 2009 in the event B1, and an 6 kWh of electric power which is charged from an electric power company at a storage temperature of 13 degrees, at 1 am, Nov. 10, 2009 in the event B2. The total electric power is 18 kWh, but when being re-measured directly before the electric power transaction with the first electric-power transaction apparatus 1, this is changed to 15 kWh at a storage battery temperature of 18 degrees, at 10:57:30 AM, Dec. 10, 2009, in the event B3. In this way, the electric power amount extracted from the storage battery is changed due to the difference between temperatures of the storage batteries or the influence of the self-discharging of the storage battery.

Then, the re-measured electric power amount of 15 kWh is divided and returns to the electric power generated by the solar power generating apparatus and the electric power charged by the electric power company. In the events B1 and B2, since the ratio of the electric power generated by the solar power generating apparatus to the electric power charged from the electric power company is 12 kWh: 6 kWh=2:1, 15 kWh in the event B3 is divided according to this ratio. As a result, the electric power of 5 kWh which is charged from the electric power company in the event B4 and the 10 kWh of electric power which is generated by the solar power generating apparatus in the event B5 are stored in the storage battery 3B. In this way, in a case where the electric power stored in the storage battery is increased or decreased as a result of the re-measurement, a process is performed such that the increase or decrease is allocated at the same ratio as that of the respective storage amounts before the re-measurement.

Further, the electric power transaction is performed between the electric power information (3) stored in the storage battery 3B and the electric power information (1B) stored in the storage battery 3A, in events B6 and B7. Since the electric power information (3) in the event B6 is transacted with the electric power information (1B), the information about the “electric power transaction” in the “current information” of the event B6 is “completed”, and the electric power transaction completion is displayed.

Further, since the electric power information (1B) in the event B7 is electric power of a relatively low value (20 Yen/kWh) obtained by exchange with the electric power information (3), information about the “electric power usage” and the “electric power transaction” among the “current information” in the event B7 is set to “allowed”, to thereby maintain a state where the electric power usage and the electric power transaction are allowed.

As described above, a history of the electric power transaction is stored in the first electric power information storage unit 14A and the second electric power information storage unit 14B, as shown in FIGS. 4 and 5, respectively. The electric power transaction history remains in the first electric-power transaction apparatus 1 and the second electric-power transaction apparatus 5, a follow-up is available in the future with reference to the first electric-power transaction apparatus 1 and the second electric-power transaction apparatus 5. Further, it is possible to prevent arbitrary editing by an electric power holder, to thereby enhance the reliability of the electric power transaction.

As a result of the re-measurement, the process when the electric power stored in the storage battery is increased or decreased is not limited to the process of allocating the increase or decrease at the same ratio as that of the respective stored electric power amounts before the re-measurement, and for example, a process of increasing or decreasing only the low value electric power for allocation may be considered.

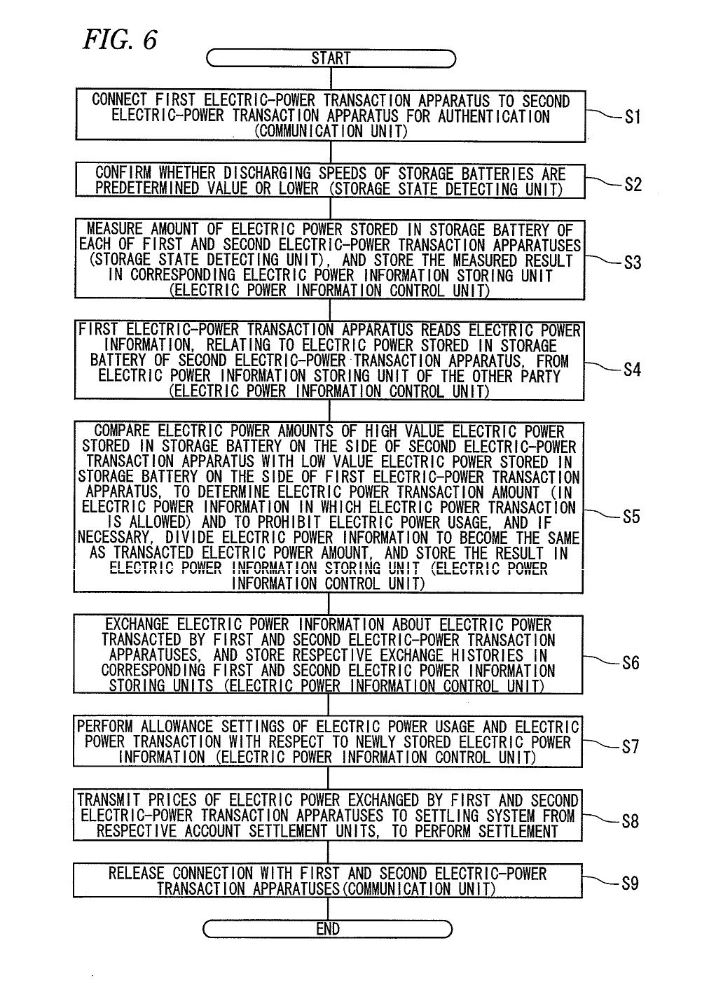

Next, an operation of the electric-power transaction apparatus according to the first embodiment of the present invention will be described with reference to a flowchart shown in FIG. 6. An element (for example, the electric power information control unit 15A) which performs each step is described together with description of each step.

The communication units 22A and 22B of the first and second electric-power transaction apparatuses 1 and 5 perform mutual authentication by connection of the first electric-power transaction apparatus 1 and the second electric-power transaction apparatus 5. That is, mutual authentication IDs are exchanged during initial connection to perform authentication (step 1).

After the first electric-power transaction apparatus 1 and the second electric-power transaction apparatus 5 are connected to each other and the authentication is performed, the storage state detecting units 11A and 11B of the first and second electric-power transaction apparatuses 1 and 5 measure the discharging speeds of the storage batteries 3A and 3B to confirm whether the discharging speeds are a predetermined value or lower (step 2). That is, since the electric power is reduced while each of the storage batteries 3A and 3B is being discharged (while electric power is being used), the discharging speeds of the storage batteries 3A and 3B are measured so that electric power transaction is not performed at that time.

After it is confirmed that the discharging speeds of the storage batteries 3A and 3B are the predetermined value or lower, the storage state detecting units 11A and 11B of the first and second electric-power transaction apparatuses 1 and 5 re-measure the amounts of the electric power stored in the storage batteries 3A and 3B, respectively. The measurement results are stored in the electric power information storage units 14A and 14B by the electric power information control units 15A and 15B (step 3).

After the measurement results of the amounts of the electric power stored in the storage batteries 3A and 3B are stored in the electric power information storage units 14A and 14B, the electric power information control unit 15A of the first electric-power transaction apparatus 1 reads the second electric power information relating to the storage battery 3B of the electric vehicle 100 on the side of the second electric-power transaction apparatus 5 from the electric power information storage units 14B of the second electric-power transaction apparatus 5 (step 4). The reading target has only to be information about the electric power which is currently stored, and thus, it is not necessary to read records of past electric power transaction.

After reading the second electric power information relating to the storage battery 3B of the electric vehicle 100, the electric power information control unit 15A compares the electric power amount of the high value electric power stored in the storage battery 3B on the side of the second electric-power transaction apparatus 5 with the electric power amount of the low value electric power stored in the storage battery 3A on the side of the first electric-power transaction apparatus 1, to determine the electric power transaction amount (here, in the electric power information in which the electric power transaction is allowed), and to set the transacted electric power to “usage prohibited”. Here, if necessary, the first electric power information is divided to become the same as the transacted electric power amount, and is stored in the electric power information storage unit 14A (step 5). Here, the transacted electric power amount has a smaller electric power amount as a result of the comparison of the high value electric power amount and the low value electric power amount, as a maximum value.

Then, the respective electric power information control units 15A and 15B exchange the electric power information about the electric power transacted by the respective first and second electric-power transaction apparatuses 1 and 5, and store the exchanged electric power information in the electric power information storage units 14A and 14B (step 6). Next, each of the electric power information control units 15A and 15B performs allowance settings of the electric power usage and the electric power transaction with respect to the newly stored electric power information (step 7).

Then, prices of the electric power exchanged by the respective electric power information control units 15A and 15B are transmitted to the account settlement unit 6 from the respective account settlement units 23A and 23B to perform settlement (step 8). After the electric power price settlement, the respective communication units 22A and 22B of the first and second electric-power transaction apparatuses 1 and 5 release the connection with the other party (step 9).

As described above, the electric-power transaction apparatus 1 according to the present embodiment includes the first electric power information storage unit 14A which stores the first electric power information including the amount of electric power stored in the storage battery 3A and the electric power value information which is the information relating to the value of the electric power amount, the communication unit 22A which receives the second electric power information from the second electric-power transaction apparatus 5 which stores the second electric power information including the amount of electric power stored in the storage battery 3B of the electric vehicle 100 and the electric power value information relating to the value of the electric power amount, and the electric power information control unit 15A which performs the electric power transaction between the storage battery 3A and the storage battery 3B on the basis of the first electric power information and the second electric power information. The electric power information control unit 15A compares the pieces of electric power value information in the specific electric power amount between the electric power amount of the storage battery 3A and the electric power amount of the storage battery 3B, and swaps and stores, when the pieces of electric power information having different electric power value information in the specific electric power amount are present in the storage batteries 3A and 3B, the pieces of electric power value information in the first electric power information storage unit 14A and the second electric power information storage unit 14B of the second electric-power transaction apparatus 5. Thus, it is possible to perform electric power transaction with high reliability between a person who desires to sell high value electric power and a person using low value electric power who desires to obtain high value electric power.

Further, according to the electric-power transaction apparatus 1 of the present embodiment, since the first electric power information is divided into the plurality of pieces of electric power information in order to compare the pieces of electric power value information in the specific electric power amount between the electric power amount of the storage battery 3A and the electric power amount of the storage battery 3B, it is easy to compare the pieces of electric power value information in the specific electric power amount, and thus, it is possible to perform electric power transaction with high reliability.

Further, according to the electric-power transaction apparatus 1 of the present embodiment, since the discharging speed of the storage battery 3A is confirmed, it is possible to prevent the electric power transaction while the storage battery 3A is being discharged (that is, while the electric power is being used), and it is possible to perform electric power transaction with high reliability.

Further, according to the electric-power transaction apparatus 1 of the present embodiment, since the amount of electric power stored in the storage battery 3A is re-measured and the first electric power information is updated before the pieces of electric power value information are compared in the specific electric power amount, it is possible to perform electric power transaction with high reliability.

Since the electric-power transaction apparatus 5 has the same function as in the electric-power transaction apparatus 1, the same effect can be obtained.

Accordingly, in steps 4 and 5, the electric power information control unit 15A of the first electric-power transaction apparatus 1 reads the second electric power information relating to the storage battery 3B from the electric power information storage unit 14B of the second electric-power transaction apparatus 5 to determine the electric power transaction amount, but contrarily, the electric power information control unit 15B of the second electric-power transaction apparatus 5 may read the first electric power information relating to the storage battery 3A from the electric power information storage unit 14A of the first electric-power transaction apparatus 1 to determine the electric power transaction amount.

When the plurality of electric-power transaction apparatuses is connected, for example, the electric-power transaction apparatus on the side of a larger storage amount as a result of comparison of the electric power stored in the storage batteries 3A and 3B in step 4 determines the electric power transaction amount.

Further, the electric-power transaction apparatus 1 and the electric-power transaction apparatus 5 may be configured by an exclusive circuit, but the control method of the electric-power transaction apparatus may be programmed using a computer so that the program is executed on the computer.

In the first embodiment, the above-described temperature detecting units 12A and 12B are not essential configurations in the present invention. In this case, in the electric power information shown in FIGS. 4 and 5, the “storage battery temperature” is not recorded. Further, in the first embodiment, the above-described time counting units 13A and 13B are not essential configurations. In this case, in the electric power information shown in FIGS. 4 and 5, the “event occurrence time” is not recorded.

### Second Embodiment

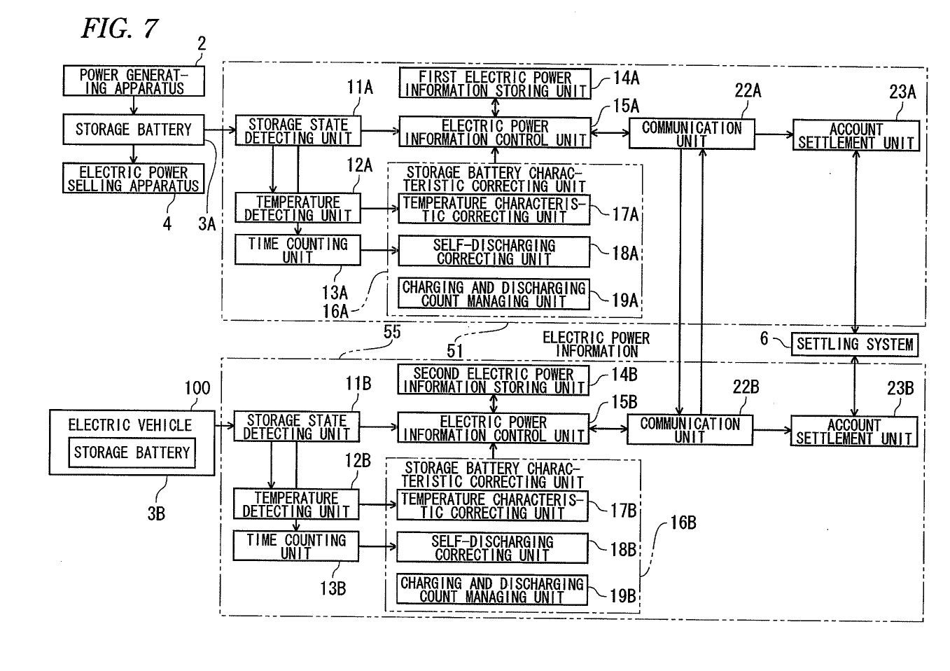

FIG. 7 is a block diagram schematically illustrating a configuration of an electric-power transaction apparatus according to a second embodiment of the present invention. In FIG. 7, the same reference numerals are given to the same units as in FIG. 1, and detailed description thereof will be omitted.

The storage battery 3A is connected to a first electric-power transaction apparatus 51 according to the present embodiment. The storage battery 3A stores electric power generated by the power generating apparatus 2. Further, the electric power selling apparatus 4 through which the electric power is sold in practice is connected to the storage battery 3A.

First and second electric-power transaction apparatuses 51 and 55 according to the present embodiment include storage battery characteristic correcting units 16A and 16B, respectively. The storage battery characteristic correcting unit 16A includes a temperature characteristic correcting unit 17A, a self-discharging correcting unit 18A, and a charging and discharging count managing unit 19A. Similarly, the storage battery characteristic correcting unit 16B includes a temperature characteristic correcting unit 17B, a self-discharging correcting unit 18B, and a charging and discharging count managing unit 19B.

Here, in the present invention, since electric power transaction is not performed by charging and discharging but is performed by replacement of numerical values or data, it is necessary to correctly detect the physical characteristics of the storage batteries in order to enhance the reliability in the electric power transaction. That is, since all the storage batteries do not necessarily have the same physical characteristics, there is individual difference, and there may be deterioration due to changes over time, it is necessary to correctly detect the physical characteristics of the storage batteries. It is possible to maintain the reliability in the electric power transaction by detecting the physical characteristics of the storage batteries.

Further, in the present embodiment, temperature characteristics of the storage batteries and influence of self-discharging are calculated by computation. Thus, it is possible to set a standard model of temperature and self-discharging for the electric power transaction. For example, it is possible to make a provision that the electric power transaction shall be performed for electric power which is stored in a state where the temperature of the storage battery is 25 degrees and the self-discharging is 1 percentage or less.

The storage battery characteristic correcting unit 16A stores the storage characteristics of the storage battery 3A, and corrects the amount of electric power stored in the storage battery 3A using the storage characteristics before the electric power information control unit 15A compares the pieces of electric power value information in the specific electric amount, and updates the first electric power information for the electric power transaction. In a similar way to the storage battery characteristic correcting unit 16A, the storage battery characteristic correcting unit 16B stores the storage characteristics of the storage battery 3B, corrects the amount of electric power stored in the storage battery 3B using the storage characteristics before the electric power information control unit 15B compares the pieces of electric power value information in the specific electric amount, and updates the second electric power information for the electric power transaction.

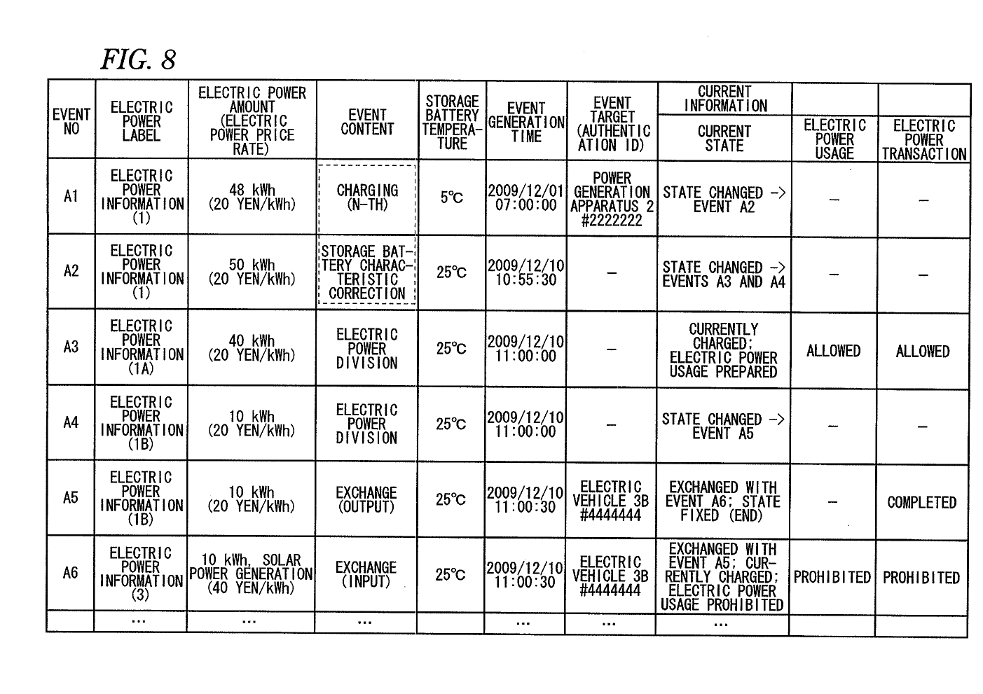

As a first storage battery characteristic correction, the temperature characteristic correcting unit 17A stores characteristics of the storage amount and temperature of the storage battery 3A, corrects the amount of electric power stored in the storage battery 3A from the temperature when the storage amount is measured and the temperature (measured temperature) when the electric power transaction is performed, using the characteristics, before the electric power information control unit 15A compares the pieces of electric power value information in the specific electric amount, and updates the first electric power information for the electric power transaction. Here, the temperature measured by the temperature detecting unit 12A when the amount of electric power stored in the storage battery 3A is measured is included in the “storage battery temperature” in FIG. 8 as information relating to the measured temperature of the storage battery 3A, in the first electric power information.

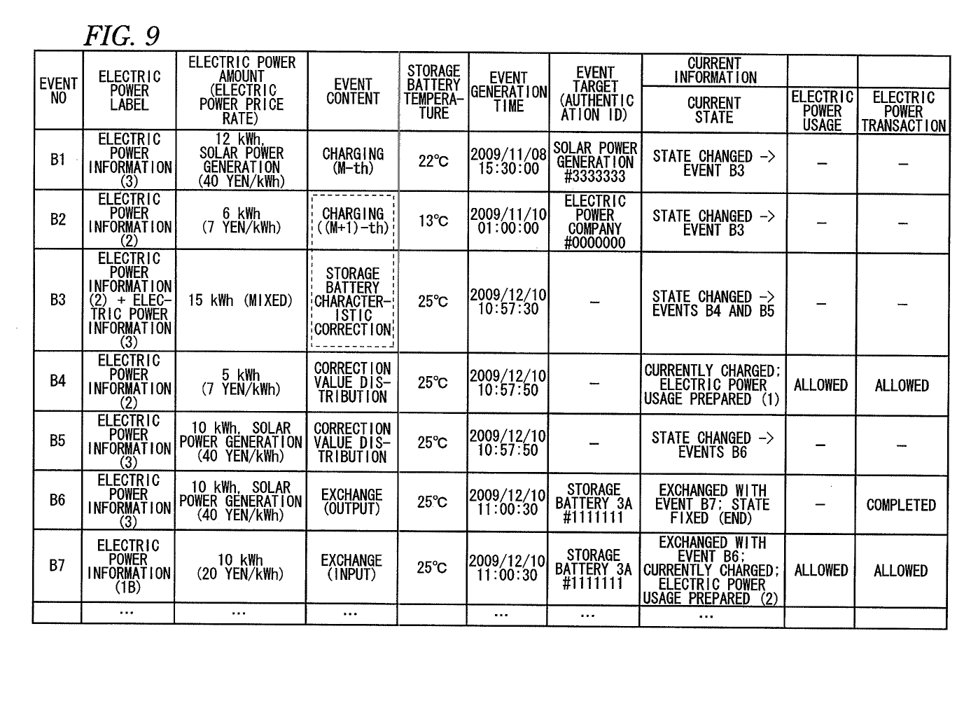

In a similar way to the temperature characteristic correcting unit 17A, the temperature characteristic correcting unit 17B stores characteristics of the storage amount and temperature of the storage battery 3B, corrects the amount of electric power stored in the storage battery 3B from the temperature when the storage amount is measured and the temperature (measured temperature) when the electric power transaction is performed, using the characteristics, before the electric power information control unit 15B compares the pieces of electric power value information in the specific electric amount, and updates the second electric power information for the electric power transaction. Here, the temperature measured by the temperature detecting unit 12B when the amount of electric power stored in the storage battery 3B is measured is included in the “storage battery temperature” in FIG. 9 as information relating to the measured temperature of the storage battery 3A, in the second electric power information.

Here, a correction formula using the temperature characteristics will be described. The storage battery can calculate the corrected electric power amount of the storage amount which is changed according to temperature by the following formula (1).

Corrected electric power amount=electric power amount measured in the past×(temperature coefficient of temperature at the time of electric power transaction/temperature coefficient of temperature at the time of measurement in the past) (1)

The temperature coefficient of the temperature at the time of electric power transaction is set to a storage amount “1” at 25 degrees, for example, which is the value of the storage amount at the temperature and is changed according to the storage batteries. In this respect, the correction may be performed with reference to a different calculation formula or characteristic curve data, instead of the formula (1).

As a second storage battery characteristic correction, the self-discharging correcting unit 18A stores characteristics of the storage amount and elapsed time of the storage battery 3A, corrects the amount of electric power stored in the storage battery 3A from the time (measured time) when the storage amount is measured and the time when the electric power transaction is performed, using the characteristics, before the electric power information control unit 15A compares the pieces of electric power value information in the specific electric amount, and updates the first electric power information for the electric power transaction. Here, the measured time measured by the time counting unit 13A when the amount of electric power stored in the storage battery 3A is measured is included in the “event occurrence time” in FIG. 8 as information relating to the measured time of the storage battery 3A, in the first electric power information.

In a similar way to the self-discharging correcting unit 18A, the self-discharging correcting unit 18B stores characteristics of the storage amount and elapsed time of the storage battery 3B, corrects the amount of electric power stored in the storage battery 3B from the measured time and the time when the electric power transaction is performed, using the characteristics, before the electric power information control unit 15B compares the pieces of electric power value information in the specific electric amount, and updates the second electric power information for the electric power transaction. Here, the measured time measured by the time counting unit 13B when the amount of electric power stored in the storage battery 3B is measured is included in the “event occurrence time” in FIG. 9 as information relating to the measured time of the storage battery 3B, in the second electric power information.

Here, a correction formula using the self-discharging characteristic will be described. Since the storage amount is reduced according to the elapsed time after charging, correction is performed. At this time, the corrected electric power amount can be calculated by the following formula (2).

Corrected electric power amount=electric power amount measured in the past×self-discharging coefficient of storage battery×(electric power transaction time−time at the time of measurement in the past) (2)

Since the self-discharging coefficient of the storage battery is changed according to the storage batteries, the coefficients are stored in advance in the self-discharging correcting units 18A and 18B. Further, the time at the time of measurement in the past is included in the first and second electric power information. In this respect, the correction may be performed with reference to a different calculation formula or characteristic curve data, instead of the formula (2).

Further, the charging and discharging count managing unit 19A manages the number of charge and discharge cycles of the storage battery 3A, determines the number of charge and discharge cycles of the storage battery 3A before the electric power information control unit 15A compares the pieces of electric power value information in the specific electric amount, and determines that the storage battery 3A reaches its life duration when the number of charge and discharge cycles of the storage battery 3A is a predetermined count or more to prohibit the electric power transaction process.

FIG. 8 is a diagram illustrating an example of the first electric power information stored in the first electric power information storage unit 14A of the first electric-power transaction apparatus 51. The fact that the temperature characteristics correction and the self-discharging correction as described above are performed before the electric power transaction is recorded in the event A2. The number of charge and discharge cycles counted by the charging and discharging count managing unit 19A every charging or discharging time is recorded in the “event content” of the event A1 at the time of charging.

Returning to FIG. 7, the charging and discharging count managing unit 19B manages the number of charge and discharge cycles of the storage battery 3B, and determines the number of charge and discharge cycles of the storage battery 3B before the electric power information control unit 15B compares the pieces of electric power value information in the specific electric amount and determines that the storage battery 3B reaches its life duration when the number of charge and discharge cycles of the storage battery 3B is a predetermined count or more to prohibit the electric power transaction process.

FIG. 9 is a diagram illustrating an example of the second electric power information stored in the second electric power information storage unit 14B of the second electric-power transaction apparatus 55. The fact that the temperature characteristics correction and the self-discharging correction as described above are performed before the electric power transaction is recorded in the event B3. The number of charge and discharge cycles counted by the charging and discharging count managing unit 19B every charging or discharging time is recorded in the “event content” of the events B1 and B2 at the time of charging.

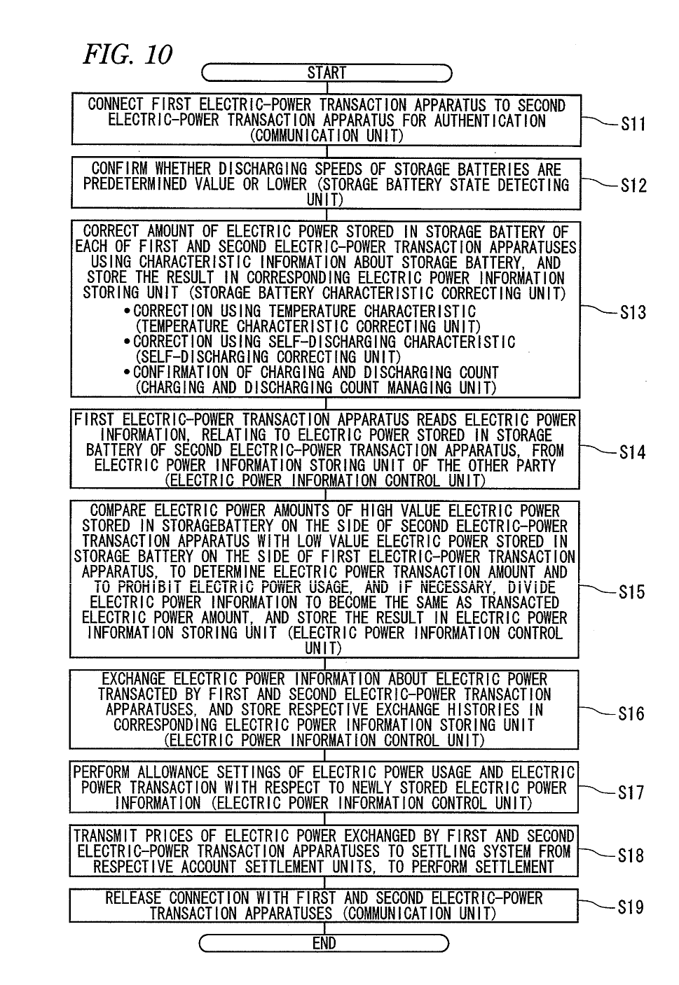

Next, an operation of the electric-power transaction apparatus according to the second embodiment of the present invention will be described with reference to a flowchart shown in FIG. 10. An element (for example, the electric power information control unit 15A) which performs each step is described together with description of each step.

The communication units 22A and 22B of the first and second electric-power transaction apparatuses 51 and 55 perform mutual authentication by connection of the first electric-power transaction apparatus 51 and the second electric-power transaction apparatus 55. That is, mutual authentication IDs are exchanged during initial connection to perform authentication (step 11).

After the first electric-power transaction apparatus 51 and the second electric-power transaction apparatus 55 are connected to each other and the authentication is performed, the storage state detecting units 11A and 11B of the first and second electric-power transaction apparatuses 51 and 55 measure the discharging speeds of the storage batteries 3A and 3B to confirm whether the discharging speeds are a predetermined value or lower (step 12). That is, since the electric power is reduced while each of the storage batteries 3A and 3B is being discharged (while the electric power is being used), the discharging speeds of the storage batteries 3A and 3B are measured so that electric power transaction is not performed at that time.

After it is confirmed that the discharging speeds of the storage batteries 3A and 3B are the predetermined value or lower, the storage state detecting units 11A and 11B correct the amounts of the electric power stored in the storage batteries 3A and 3B using the characteristic information of the respective storage batteries 3A and 3B, and store the respective corrected electric power amounts in the first and second electric power information storage units 14A and 14B (step 13). In this case, the correction using the temperature characteristics is performed by the temperature characteristic correcting units 17A and 17B, and the correction using the self-discharging characteristic is performed by the self-discharging number correcting units 18A and 18B. Further, the confirmation of the number of charge and discharge cycles is performed by the charging and discharging count managing units 19A and 19B.

In this way, in a case where the electric power stored in the storage battery is increased or decreased as a result of the correction, a process is performed such that the increase or decrease is allocated at the same ratio as that of the respective storage amounts before the correction.

After the correction results of the amounts of the electric power stored in the storage batteries 3A and 3B are stored in the electric power information storage units 14A and 14B, the electric power information control unit 15A of the first electric-power transaction apparatus 51 reads the second electric power information relating to the storage battery 3B of the electric vehicle 100 on the side of the second electric-power transaction apparatus 5 from the second electric power information storage units 14B of the second electric-power transaction apparatus 55 (step 14).

After reading the second electric power information relating to the storage battery 3B of the electric vehicle 100, the electric power information control unit 15A compares the electric power amount of the high value electric power stored in the storage battery 3B on the side of the second electric-power transaction apparatus 55 with the electric power amount of the low value electric power stored in the storage battery 3A on the side of the first electric-power transaction apparatus 51, to determine the electric power transaction amount (here, in the electric power information in which the electric power transaction is allowed), and to set the transacted electric power to “usage prohibited”. Here, if necessary, the first electric power information is divided to become the same as the transacted electric power amount, and is stored in the electric power information storage unit 14A (step 15). Here, the transacted electric power amount has a smaller electric power amount as a result of the comparison of the high value electric power amount and the low value electric power amount, as a maximum value.

Then, the respective electric power information control units 15A and 15B exchange the electric power information about the electric power transacted by the respective first and second electric-power transaction apparatuses 51 and 55, and store the exchanged electric power information in the electric power information storage units 14A and 14B (step 16). Next, each of the electric power information control units 15A and 15B performs allowance settings of the electric power usage and the electric power transaction with respect to the newly stored electric power information (step 17).

Then, prices of the electric power exchanged by the respective electric power information control units 15A and 15B are transmitted to the account settlement system 6 from the respective account settlement units 23A and 23B to perform settlement (step 18). After the electric power price settlement, the respective communication units 22A and 22B of the first and second electric-power transaction apparatuses 51 and 55 release the connection with the other party (step 19).

As described above, the electric-power transaction apparatus 51 of the present embodiment includes the storage battery characteristic correcting unit 16A which includes the temperature characteristic correcting unit 17A which stores the characteristics of the storage amount and temperature of the storage battery 3A, the self-discharging correcting unit 18A which stores the characteristics of the storage amount and elapsed time of the storage battery 3A, and the charging and discharging count managing unit 19A which manages the number of charge and discharge cycles of the storage battery 3A. Further, before the pieces of electric power value information in the specific electric power amount are compared, the electric power information control unit 15A corrects the amount of electric power stored in the storage battery 3A by the temperature characteristic correcting unit 17A and the self-discharging correcting unit 18A, determines the number of charge and discharge cycles of the storage battery 3A by the charging and discharging count managing unit 19A, and determines that the storage battery 3A reaches its life duration when the number of charge and discharge cycles of the storage battery 3A is the predetermined number or more to prohibit the electric power transaction process. Thus, it is possible to enhance the reliability of the electric power transaction.

Since the electric-power transaction apparatus 55 has the same function as in the electric-power transaction apparatus 51, the same effect can be obtained.

Accordingly, in steps 14 and 15, the electric power information control unit 15A of the first electric-power transaction apparatus 51 reads the second electric power information relating to the storage battery 3B from the electric power information storage unit 14B of the second electric-power transaction apparatus 55 to determine the electric power transaction amount, but contrarily, the electric power information control unit 15B of the second electric-power transaction apparatus 55 may read the first electric power information relating to the storage battery 3A from the electric power information storage unit 14A of the first electric-power transaction apparatus 51 to determine the electric power transaction amount.

When the plurality of electric-power transaction apparatuses is connected, for example, the electric-power transaction apparatus on the side of a larger storage amount as a result of comparison of the electric power stored in the storage batteries 3A and 3B in step 14 determines the electric power transaction amount.

Further, the electric-power transaction apparatus 51 and the electric-power transaction apparatus 55 may be configured by an exclusive circuit, but the control method of the electric-power transaction apparatus may be programmed using a computer so that the program is executed on the computer.

In the second embodiment, the temperature correcting units 17A and 17B and the self-discharging correcting units 18A and 18B as described above are not essential configurations in the present invention. Further, the charging and discharging count managing units 19A and 19B are not essential configuration. In this case, in the electric power information of FIGS. 8 and 9, the “charging and discharging count” is not recorded. Further, in a case where the storage battery characteristic correcting units 16A and 16B are not provided, the temperature detecting units 12A and 13B or the time counting units 13A and 13B are not essential.

### Third Embodiment

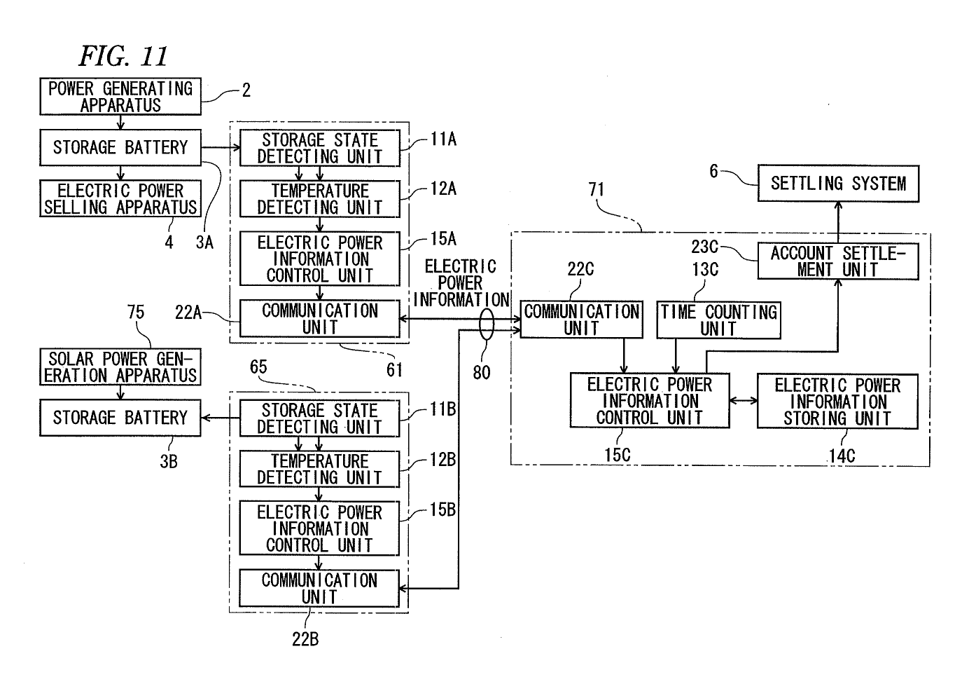

FIG. 11 is a block diagram schematically illustrating a configuration of an electric-power transaction apparatus according to a third embodiment of the present invention. In FIG. 11, the same reference numerals are given to the same units as in FIG. 1, and detailed description thereof will be omitted.

In FIG. 11, a first electric-power transaction apparatus 61 includes the storage state detecting unit 11A, the temperature detecting unit 12A, the electric power information control unit 15A and the communication unit 22A. The storage battery 3A is connected to the first electric-power transaction apparatus 61, and the storage battery 3A stores electric power generated by the power generating apparatus 2. Further, the electric power selling apparatus 4 through which the electric power is sold in practice is connected to the storage battery 3A.

In a similar way to the first electric-power transaction apparatus 61, a second electric-power transaction apparatus 65 includes the storage state detecting unit 11B, the temperature detecting unit 12B, the electric power information control unit 15B and the communication unit 22B. The storage battery 3B is connected to the second electric-power transaction apparatus 65, and the storage battery 3B stores electric power generated by a solar power generating apparatus 75. Further, the power generating apparatus which charges the storage battery 3B is not limited to the solar power generating apparatus 75, and may include any power generating apparatus which is capable of obtaining high value electric power using natural energy, such as a wind power generating apparatus.

A third electric-power transaction apparatus 71 includes a time counting unit 13C, an electric power information storing unit 14C, an electric power information control unit 15C, a communication unit 22C and an account settlement unit 23C. The first electric-power transaction apparatus 61 and the second electric-power transaction apparatus 65 are connected to the third electric-power transaction apparatus 71 through a communication line 80.

Accordingly, the present embodiment is different from the first embodiment in that the first, second and third electric-power transaction apparatuses 61, 65 and 71 are connected through the communication line 80 and units which can be shared by the first electric-power transaction apparatus 61 and the second electric-power transaction apparatus 65 are included in the third electric-power transaction apparatus 71. Particularly, since the electric power information about each storage battery is stored in the electric power information storage unit 14C of the electric-power transaction apparatus 71 for management, it is difficult to arbitrarily rewrite the electric power information, to thereby enhance the reliability of the electric power information.

In the system configuration shown in FIG. 11, instead of the electric power information storage unit 14C (first electric power information storing means and second electric power information storing means), like the first electric power information storage unit 14A and the second electric power information storage unit 14B in FIG. 1, the electric power information storage unit may be included in each electric-power transaction apparatus. In this case, the electric power information control unit 15C includes first electric power information obtaining means and second electric power information obtaining means, obtains the electric power information relating to the storage battery 3A, that is, the first electric power information from the first electric power information storage unit 14A using the first electric power obtaining means, and obtains the electric power information relating to the storage battery 3B, that is, the second electric power information from the second electric power information storage unit 14B using the second electric power obtaining means.

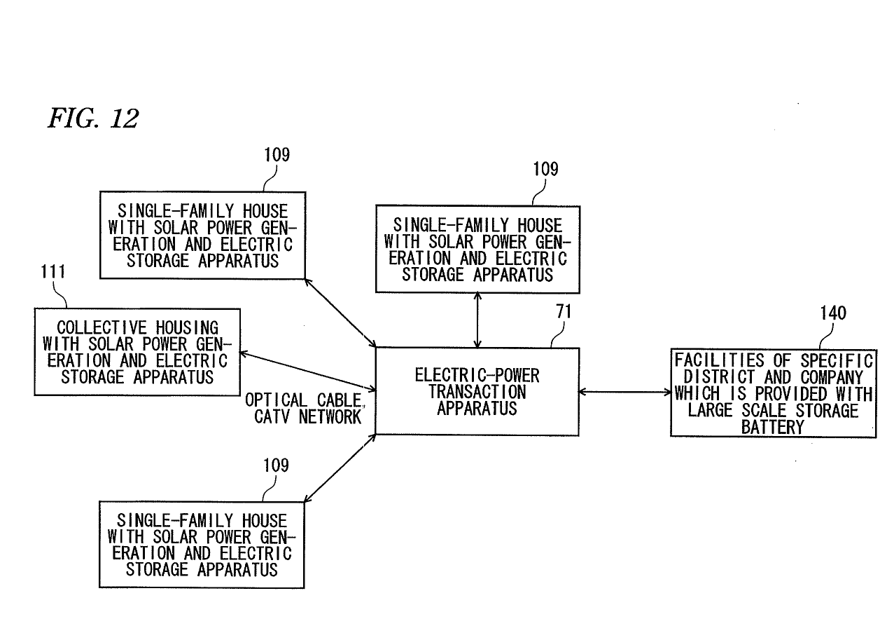

FIG. 12 is a diagram schematically illustrating the outline of electric power transaction through an information communication network using the electric-power transaction apparatus according to the present embodiment. In FIG. 12, the first electric-power transaction apparatus 61 shown in FIG. 11 is installed in a facility 140 of a specific district, a company or the like which is provided with a large scale storage battery, and the second electric-power transaction apparatus 65 is installed in a house 109 or a collective housing 111 in which the solar power generating apparatus 75 and the storage battery 3B are introduced. Further, the electric-power transaction apparatus 71 is installed between the first electric-power transaction apparatus 61 and the second electric-power transaction apparatus 65.

In FIG. 2, the electric power generated from the solar power generating apparatus is stored in the electric vehicle, and the electric power transaction is performed when the electric vehicle is parked in the commercial facility, but in FIG. 12, electric power generated from the solar power generating apparatus or the like is stored in the storage battery of the house, and the electric power transaction with a storage battery of the other party which is connected to the information communication network can be performed any time.

In the house 109 or the collective housing 111 in which the solar power generating apparatus 75 and the storage battery 3B are introduced and the second electric-power transaction apparatus 65 is introduced, high value electric power obtained by the solar power generation is sold to the facility 140 in which the first electric-power transaction apparatus 61 is installed through the third electric-power transaction apparatus 71, and low value electric power obtained in the facility 40 is purchased through the third electric-power transaction apparatus 71. As described above, electric power transaction is not performed by charging and discharging but is performed by exchanging numerical values or data.

In the third electric-power transaction apparatus 71, the electric power information storage unit 14C stores the first electric power information which includes the amount of electric power stored in the storage battery 3A on the side of the first electric-power transaction apparatus 61 and the electric power value information which is the information relating to the value of the electric power amount and first identification information for identifying the storage battery 3A, and stores the second electric power information which includes the amount of electric power stored in the storage battery 3B on the side of the second electric-power transaction apparatus 65 and the information relating to the value of the electric power amount and second identification information for identifying the storage battery 3B. That is, the first electric power information and the second electric power information are stored in the electric power information storage unit 14C for each identification information.

The electric power information control unit 15C includes the first electric power information obtaining means and the second electric power information obtaining means, and performs the electric power transaction between the storage battery 3A and the storage battery 3B on the basis of the first electric power information stored in the electric power information storage unit 14C obtained by the first electric power information obtaining means and the second electric power information obtained by the second electric power information obtaining means. Specifically, the electric power information control unit 15C compares the pieces of electric power value information in the specific electric power amount between the electric power amount of the storage battery 3A and the electric power amount of the storage battery 3B, and swaps and stores, when the pieces of electric power information having different electric power value information in the specific electric power amount are present in the storage batteries 3A and 3B, the pieces of electric power value information in the electric power information storage unit 14C.

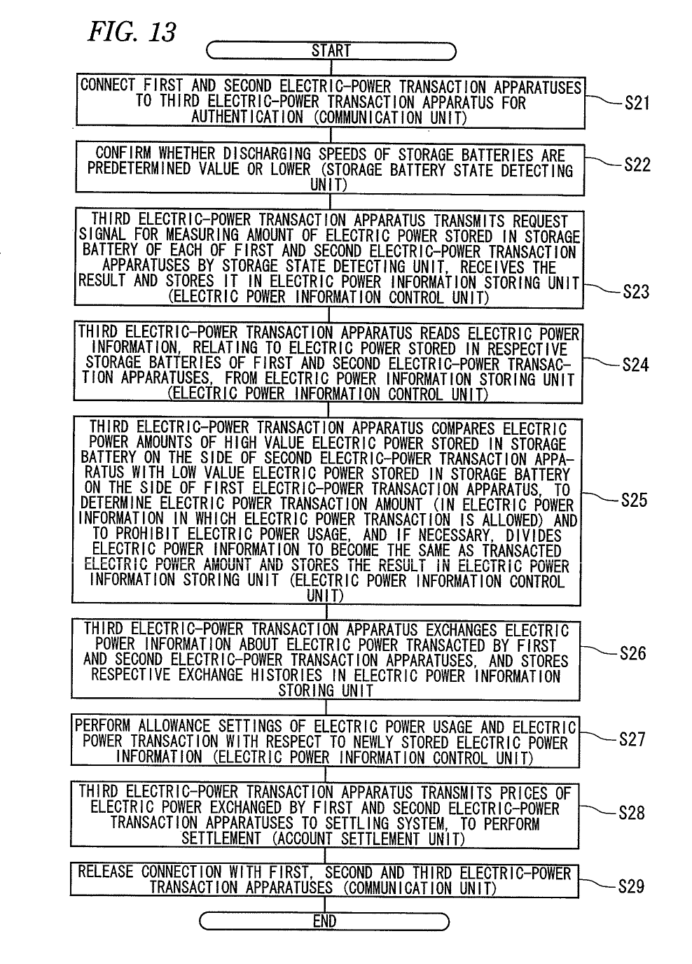

Next, an operation of the electric-power transaction apparatus according to the present embodiment will be described with reference to a flowchart shown in FIG. 13. An element (for example, the electric power information control unit 15A) which performs each step is described together with description of each step.

The communication unit 22A of the first electric-power transaction apparatus 61 and the communication unit 22C of the third electric-power transaction apparatus 71 perform mutual authentication by connection of the first electric-power transaction apparatus 61 and the third electric-power transaction apparatus 71 through the communication line 80. Further, the communication unit 22B of the second electric-power transaction apparatus 65 and the communication unit 22C of the third electric-power transaction apparatus 71 perform mutual authentication by connection of the second electric-power transaction apparatus 65 and the third electric-power transaction apparatus 71 through the communication line 80 (step 21).

That is, mutual authentication IDs are exchanged at an initial connection time of the first electric-power transaction apparatus 61 and the third electric-power transaction apparatus 71 and at an initial connection time of the second electric-power transaction apparatus 65 and the third electric-power transaction apparatus 71 to perform to perform authentication, and thus, the electric power information control unit 15C is allowed to handle both of the electric power information stored in the electric power information storage unit 14C, relating to the electric power stored by the first electric-power transaction apparatus 61 and the electric power information relating to the electric power stored by the second electric-power transaction apparatus 65, to thereby perform the electric power transaction.

After the first electric-power transaction apparatus 61 and the second electric-power transaction apparatus 65 are respectively connected to the third electric-power transaction apparatus 71 and the authentications are performed, the storage state detecting units 11A and 11B of the first and second electric-power transaction apparatuses 61 and 65 measure the discharging speeds of the storage batteries 3A and 3B to confirm whether the discharging speeds are a predetermined value or lower (step 22). That is, since the electric power is reduced while each of the storage batteries 3A and 3B is being discharged (while electric power is being used), the discharging speeds of the storage batteries 3A and 3B are measured so that electric power transaction is not performed at that time.

After it is confirmed that the measured discharging speeds of the storage batteries 3A and 3B are the predetermined value or lower, the electric power information control unit 15C of the third electric-power transaction apparatus 71 transmits a request signal for re-measuring the electric power amounts of the storage batteries 3A and 3B, to the first and second electric-power transaction apparatuses 61 and 65, respectively. As the request signal is transmitted, the electric power amounts of the storage batteries 3A and 3B are re-measured by the first and second electric-power transaction apparatuses 61 and 65 and the results are transmitted. If the measured electric power amounts of the storage batteries 3A and 3B are received, the electric power information control unit 15C stores the received electric power amounts of the storage batteries 3A and 3B in the electric power information storage unit 14C (step 23). For example, the first electric power information is as shown in FIG. 4, and the second electric power information is as shown in FIG. 5.

After the electric power amounts of the storage batteries 3A and 3B are stored in the electric power information storage unit 14C, the electric power information control unit 15C obtains and reads the stored electric power information using the first electric power information obtaining means and the second electric power information obtaining means (step 24), and compares the electric power amounts of the high value electric power stored in the storage battery 3B on the side of the second electric-power transaction apparatus 65 and the low value electric power stored in the storage battery 3A on the side of the first electric-power transaction apparatus 61, to determine the electric power transaction amount (here, in the electric power information in which the electric power transaction is allowed), and to set the transacted electric power to “usage prohibited”. Here, if necessary, the electric power information is divided to become the same as the transacted electric power amount, and is stored in the electric power information storage unit 14C (step 25). Here, the transacted electric power amount has a smaller electric power amount as a result of the comparison of the high value electric power amount and the low value electric power amount, as a maximum value.

Then, the electric power information control unit 15C exchanges the electric power information about the electric power transacted between the electric power information control unit 15A of the first electric-power transaction apparatus 61 and the electric power information control unit 15B of the second electric-power transaction apparatus 65, and respectively stores the exchanged electric power information in the electric power information of the first electric-power transaction apparatus 61 and the electric power information of the second electric-power transaction apparatus 65, in the electric power information storage unit 14C (step 26). Then, the electric power information control unit 15C performs allowance settings of the electric power usage and the electric power transaction with respect to the newly stored electric power information (step 27).

After the electric power information control unit 15C performs the allowance settings of the electric power usage and the electric power transaction with respect to the newly stored electric power information, the account settlement unit 23C of the third electric-power transaction apparatus 71 transmits the prices of the electric power exchanged by the first and second electric-power transaction apparatuses 61 and 65 to the account settlement system 6 to perform settlement (step 28). After the settlement in the electric power transaction, the respective communication units 22A, 22B and 22C of the first, second and third electric-power transaction apparatuses 61, 65 and 71 release the connection (step 29). If the connection is released, the electric power information control unit 15C is not allowed to handle the electric power information stored in the electric power information storage unit 14C, relating to the electric power stored by the first electric-power transaction apparatus 61 and the electric power information relating to the electric power stored by the second electric-power transaction apparatus 65, and thereafter, it is difficult to edit the electric power information.

As described above, since the electric-power transaction apparatus 71 of the present embodiment stores the information (first electric power information, first identification information, second electric power information and second identification information) relating to the respective storage batteries 3A and 3B in the common electric power information storage unit 14C and performs the exchange of the electric power value information on the basis of the information relating to the respective storage batteries 3A and 3B stored in the common electric power information storage unit 14C, it is not necessary that both of the first electric-power transaction apparatus 61 and the second electric-power transaction apparatus 65 include the electric power information storage unit, and thus, it is possible to reduce the size, weight and cost of each of the electric-power transaction apparatuses 61 and 65. Further, by performing management so that the information stored in the electric power information storage unit 14C cannot be edited when electric power transaction is not performed, and so that a person who is not authenticated by the authentication ID cannot edit the information stored in the electric power information storage unit 14C, it is possible to prevent arbitrary edition of the electric power information, thereby enhancing the reliability of the electric power transaction.

The electric-power transaction apparatuses 61, 65 and 71 may be configured by an exclusive circuit, but the control method of the electric-power transaction apparatus may be programmed using a computer so that the program is executed on the computer.

In the third embodiment, the above-described temperature detecting units 12A and 12B are not essential configurations in the present invention. In this case, in the electric power information of FIGS. 4 and 5, the “storage battery temperature” is not recorded. Further, in the third embodiment, the above-described time counting unit 13C is not an essential configuration. In this case, the “event occurrence time” is not recorded in the electric power information.

### Fourth Embodiment

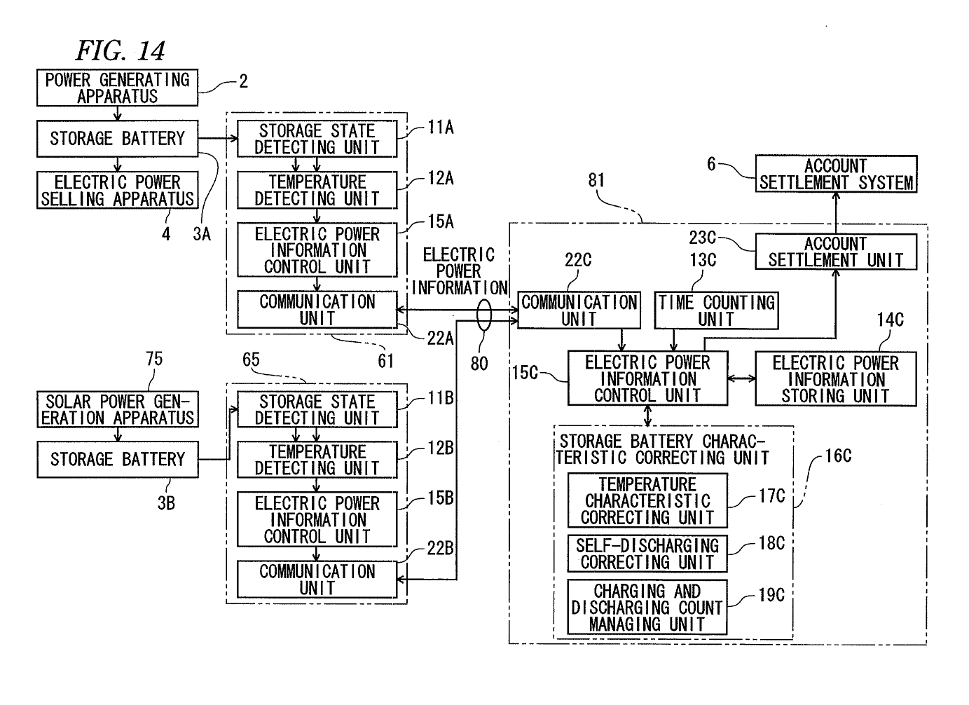

FIG. 14 is a block diagram schematically illustrating a configuration of an electric-power transaction apparatus according to a fourth embodiment of the present invention. In FIG. 14, the same reference numerals are given to the same units as in FIGS. 1 and 11, and detailed description thereof will be omitted.

In FIG. 14, the storage battery 3A is connected to the first electric-power transaction apparatus 61. The storage battery 3A stores electric power generated by the power generating apparatus 2. Further, the electric power selling apparatus 4 through which the electric power is sold in practice is connected to the storage battery 3A.

A third electric-power transaction apparatus 81 has a configuration in which a storage battery characteristic correcting unit 16C which is the same as the storage battery characteristic correcting unit 16A (16B) according to the second embodiment is added to the third electric-power transaction apparatus 71 according to the above-described third embodiment. Since the third electric-power transaction apparatus 81 includes the storage battery characteristic correcting unit 16C, it is not necessary that the first and second electric-power transaction apparatuses respectively include the storage battery characteristic correcting units as in the second embodiment.

The storage battery characteristic correcting unit 16C includes a temperature characteristic correcting unit 17C, a self-discharging correcting unit 18C, and a charging and discharging count managing unit 19C. The storage battery characteristic correcting unit 16C stores the storage characteristics of each of the storage batteries 3A and 3B, corrects the amount of electric power stored in the storage battery 3A using the storage characteristics of the storage battery 3A before the electric power information control unit 15C compares the pieces of electric power value information in the specific electric amount, and updates the first electric power information. The storage battery characteristic correcting unit 16C also corrects the amount of electric power stored in the storage battery 3B using the storage characteristics of the storage battery 3B, and updates the second electric power information.

The temperature characteristic correcting unit 17C stores characteristics of the storage amount and temperature of each of the storage batteries 3A and 3B, corrects the amount of electric power stored in the storage battery 3A from the measured temperature and the temperature at the time of electric power transaction using the characteristics of the storage battery 3A before the electric power information control unit 15C compares the pieces of electric power value information in the specific electric amount, and updates the first electric power information. The temperature characteristic correcting unit 17C also corrects the amount of electric power stored in the storage battery 3B using the characteristics of the storage battery 3B, and updates the second electric power information.

Here, the temperature measured by the temperature detecting unit 12A when the amount of electric power stored in the storage battery 3A is measured is included as information relating to the measured temperature of the storage battery 3A, in the first electric power information. Further, the temperature measured by the temperature detecting unit 12B when the amount of electric power stored in the storage battery 3B is measured is included as information relating to the measured temperature of the storage battery 3B, in the second electric power information. For example, the first electric power information is as shown in FIG. 8, and the second electric power information is as shown in FIG. 9.

The correction of the temperature characteristics in the temperature characteristic correcting unit 17C is performed to unify the electric power information at a predetermined temperature (for example, 25 degrees) to thereby perform the electric power transaction. In the method of updating the electric power amount of the storage battery by the re-measurement as in the third embodiment, the temperature of storage battery is changed according to environments where the storage battery is installed. For example, if the installation place of the storage battery is each house as in FIG. 12, it is difficult to adjust the temperature of the storage battery to be constant.

The self-discharging correcting unit 18C stores characteristics of the storage amount and elapsed time of each of the storage batteries 3A and 3B, corrects the amount of electric power stored in the storage battery 3A from the measured time and the time when the electric power transaction is performed, using the characteristics of the storage battery 3A, before the electric power information control unit 15C compares the pieces of electric power value information in a specific electric amount, and updates the first electric power information. The self charging correcting unit 18C also corrects the amount of electric power stored in the storage battery 3B from the measured time and the time when the electric power transaction is performed, using the characteristics of the storage battery 3B, before the electric power information control unit 150 compares the pieces of electric power value information in the specific electric amount, and updates the second electric power information.

Here, the measured time measured by the time counting unit 13C when the amount of electric power stored in the storage battery 3A is measured is included as information relating to the measured time of the storage battery 3A, in the first electric power information. Further, the measured time measured by the time counting unit 13C when the amount of electric power stored in the storage battery 3B is measured is included as information relating to the measured time of the storage battery 3B, in the second electric power information.

The charging and discharging count managing unit 19C manages the number of charge and discharge cycles of each of the storage batteries 3A and 3B, determines the number of charge and discharge cycles of the storage battery 3A before the electric power information control unit 15C compares the pieces of electric power value information in the specific electric amount, and determines that the storage battery 3A reaches its life duration when the number of charge and discharge cycles of the storage battery 3A is a predetermined count or more to prohibit the electric power transaction process. Further, the charging and discharging count managing unit 19C determines the number of charge and discharge cycles of the storage battery 3B, and determines that the storage battery 3B reaches its life duration when the number of charge and discharge cycles of the storage battery 3B is a predetermined count or more to prohibit the electric power transaction process.

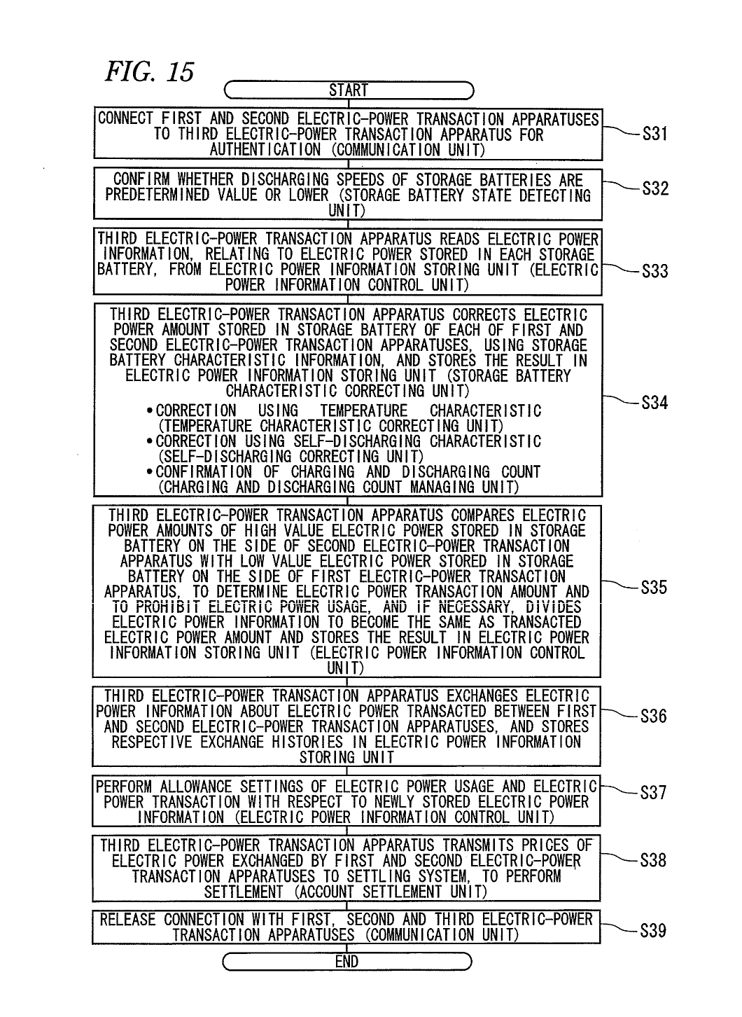

Next, an operation of the electric-power transaction apparatus according to the present embodiment will be described with reference to a flowchart shown in FIG. 15. An element (for example, the electric power information control unit 15A) which performs each step is described together with description of each step.

The communication unit 22A of the first electric-power transaction apparatus 61 and the communication unit 22C of the third electric-power transaction apparatus 81 perform mutual authentication by connection of the first electric-power transaction apparatus 61 and the third electric-power transaction apparatus 81 through the communication line 80. Further, the communication unit 22B of the second electric-power transaction apparatus 65 and the communication unit 22C of the third electric-power transaction apparatus 81 perform mutual authentication by connection of the second electric-power transaction apparatus 65 and the third electric-power transaction apparatus 81 through the communication line 80 (step 31). That is, mutual authentication IDs are exchanged at an initial connection time of the first electric-power transaction apparatus 61 and the third electric-power transaction apparatus 81 and at an initial connection time of the second electric-power transaction apparatus 65 and the third electric-power transaction apparatus 81 to perform authentication, and thus, the electric power information control unit 15C is allowed to handle both of the electric power information stored in the electric power information storage unit 14C, relating to the electric power stored by the first electric-power transaction apparatus 61 and the electric power information relating to the electric power stored by the second electric-power transaction apparatus 65, to thereby perform the electric power transaction.

After the first electric-power transaction apparatus 61 and the second electric-power transaction apparatus 65 are respectively connected to the third electric-power transaction apparatus 81 and the authentications are performed, the storage state detecting units 11A and 11B of the first and second electric-power transaction apparatuses 61 and 65 measure the discharging speeds of the storage batteries 3A and 3B to confirm whether the discharging speeds are a predetermined value or lower (step 32). That is, since the electric power is reduced while each of the storage batteries 3A and 3B is being discharged, the discharging speeds of the storage batteries 3A and 3B are measured so that electric power transaction is not performed at that time.

After the storage state detecting units 11A and 11B of the first and second electric-power transaction apparatuses 61 and 65 measure the discharging speeds of the storage batteries 3A and 3B and it is confirmed that the discharging speeds are the predetermined value or lower, the electric power information control unit 15C of the third electric-power transaction apparatus 81 reads the electric power information, relating to the electric power stored in the storage batteries 3A and 3B, from the electric power information storage unit 14C (step 33). Further, the electric power information control unit 15C corrects the amount of electric power stored in each of the storage batteries 3A and 3B of the first and second electric-power transaction apparatuses 61 and 65 using information about the characteristics of the storage batteries 3A and 3B, and stores the electric power amount after the correction in the electric power information storage unit 14C (step 34). In this case, the correction using the temperature characteristics is performed by the temperature characteristic correcting unit 17C, and the correction using the self-discharging characteristic is performed by the self-discharging characteristic correcting unit 18C. Further, the confirmation of the number of charge and discharge cycles is performed by the charging and discharging count managing unit 19C.

Next, the electric power information control unit 15C compares the electric power amount of the high value electric power stored in the storage battery 3B on the side of the second electric-power transaction apparatus 65 with the electric power amount of the low value electric power stored in the storage battery 3A on the side of the first electric-power transaction apparatus 61, to determine the electric power transaction amount, and to set the transaction electric power to “usage prohibited”. Here, if necessary, the first electric power information is divided to become the same as the transacted electric power amount, and is stored in the electric power information storage unit 14C (step 35). Here, the transacted electric power amount has a smaller electric power amount as a result of the comparison of the high value electric power amount and the low value electric power amount, as a maximum value.

Then, the electric power information control unit 15C exchanges the electric power information about the electric power transacted between the electric power information control unit 15C and each of the electric power information control unit 15A of the first electric-power transaction apparatus 61 and the electric power information control unit 15B of the second electric-power transaction apparatus 65, and respectively stores the exchanged electric power information in the electric power information of the first electric-power transaction apparatus 61 and in the electric power information of the second electric-power transaction apparatus 61, in the electric power information storage unit 14C (step 36). Next, the electric power information control unit 15C performs allowance settings of the electric power usage and the electric power transaction with respect to the newly stored electric power information (step 37).

After the electric power information control unit 15C performs the allowance settings of the electric power usage and the electric power transaction with respect to the newly stored electric power information, the account settlement unit 23C of the third electric-power transaction apparatus 81 transmits the prices of the electric power exchanged by the first and second electric-power transaction apparatuses 61 and 65 to the account settlement unit 6 to perform settlement (step 38). After the settlement in the electric power transaction, the respective communication units 22A, 22B and 22C of the first, second and third electric-power transaction apparatuses 61, 65 and 81 release the connection (step 39). The electric power information control unit 15C is not allowed to handle the electric power information stored in the electric power information storage unit 14C, relating to the electric power stored by the first electric-power transaction apparatus 61 and the electric power information relating to the electric power stored by the second electric-power transaction apparatus 65, and thereafter, it is difficult to edit the electric power information.

As described above, the electric-power transaction apparatus 81 of the present embodiment includes the storage battery characteristic correcting unit 16C which includes the temperature characteristic correcting unit 17C which stores the characteristics of the storage amount and temperature of each of the storage batteries 3A and 3B, the self-discharging correcting unit 18C which stores the characteristics of the storage amount and elapsed time of each of the storage batteries 3A and 3B, and the charging and discharging count managing unit 19C which manages the number of charge and discharge cycles of each of the storage batteries 3A and 3B. Further, the electric power information control unit 15C corrects the amount of electric power stored in each of the storage batteries 3A and 3B using the temperature characteristic correcting unit 17C and the self-discharging correcting unit 18C before comparing the pieces of electric power value information in the specific electric amount, determines the number of charge and discharge cycles of each of the storage batteries 3A and 3B, and determines that each of the storage batteries 3A and 3B reaches its life duration when the number of charge and discharge cycles is the predetermined count or more to prohibit the electric power transaction, to thereby enhance the reliability of the electric power transaction by the charging and discharging count managing unit 19C.

Further, since the electric-power transaction apparatus 81 has the same configuration as that of the electric-power transaction apparatus 71 according to the above-described third embodiment except for the storage battery characteristic correcting unit 16C, it is possible to achieve the same effect.

The electric-power transaction apparatuses 61, 65 and 81 may be configured by an exclusive circuit, but the control method of the electric-power transaction apparatus may be programmed using a computer so that the program is executed on the computer.

In the fourth embodiment, the temperature detecting unit 17C and the self-discharging correcting unit 18C as described above are not essential configurations. Further, the charging and discharging count managing unit 19C is not an essential configuration, and in this case, the “charging and discharging count” is not recorded in the electric power information. In a case where the storage battery characteristic correcting unit 16C is not provided, the temperature detecting units 12A and 12B and the time counting unit 13C are not essential configurations.

In the first to fourth embodiments, the discharging speeds of the storage batteries are measured by the storage state detecting unit, and electric power transaction is not performed when the discharging speeds are fast, but the invention is not limited thereto. The time when the storage batteries are charged or discharged may be detected by the storage state detecting unit, and when the storage batteries are charged or discharged (when the storage amount is changed), the electric power transaction may not be performed.

Alternatively, instead of the determination using the discharging speeds, the electric power transaction may be not performed when the storage state detecting unit detects that the electric power stored in the storage battery is a predetermined value or less (for example, 1 kWh). Further, by performing the electric power transaction so that a predetermined amount (for example, 1 kWh) or more remains in the storage battery, the stored electric power may not be entirely transacted at one time.

In the present embodiments, the description has been made to the electric power, but the invention is not limited thereto, and may be usefully applied to energy other than the electric power. For example, transaction of oil, gas, thermal energy or the like having different values may be handled.

That is, there may be provided an energy transaction apparatus including: first energy information storing means for storing first energy information which includes the amount of energy stored in a first energy storage device and energy value information which is information relating to the value of the energy amount; communication means for obtaining, from a different energy transaction apparatus which stores second energy information which includes the amount of energy stored in a second energy storage device and energy value information relating to the energy amount, the second energy information; and energy information control means for performing energy transaction between the first energy storage device and the second energy storage device on the basis of the first energy information and the second energy information, wherein the energy information control means compares the pieces of energy value information in a specific energy amount between the energy amount of the first energy storage device and the energy amount of the second energy storage device, and swaps and stores, when the pieces of energy information in which the pieces of energy value information in the specific energy amount are different from each other are present in both the energy storage devices, the pieces of energy value information in the first energy information storing means and the different energy transaction apparatus.

Further, there may be provided an energy transaction apparatus including: energy information storing means for storing first energy information which includes the amount of energy stored in a first energy storage device and energy value information which is information relating to the value of the energy amount and first identification information for identifying the first energy storage device, second energy information which includes the amount of energy stored in a second energy storage device and energy value information relating to the energy amount, and identification information for identifying the second energy storage device; and energy information control means for performing energy transaction between the first energy storage device and the second energy storage device on the basis of the first energy information and the second energy information, wherein the energy information control means compares the pieces of energy value information in a specific energy amount between the energy amount of the first energy storage device and the energy amount of the second energy storage device, and swaps and stores, when the pieces of energy information in which the pieces of energy value information in the specific energy amount are different from each other are present in both the energy storage devices, the pieces of energy value information in the energy information storage means.

The invention has been described in detail with reference to the specific embodiments, but it is obvious to those skilled in the art that a variety of modifications can be made without departing from the spirit and range of the invention.

The present application is based on Japanese Patent Application No. 2010-029410 filed on Feb. 12, 2010, the content of which is incorporated herein.

### INDUSTRIAL APPLICABILITY

The present invention can perform electric power transaction with high reliability between a person who desires to sell high value electric power and a person using low value electric power who desires to obtain high value electric power, and can be applied to electric vehicles, electric power facilities which can obtain electric power from natural energy such as a solar power generation or a wind power generation, and electric power facilities of a specific district or a company which is provided with a large scale energy storage.

### DESCRIPTION OF REFERENCE SIGNS

1, 51, 61: FIRST ELECTRIC-POWER TRANSACTION APPARATUS
2: POWER GENERATING APPARATUS
3A, 3B: STORAGE BATTERY
4: ELECTRIC POWER SELLING APPARATUS
5, 55, 65: SECOND ELECTRIC-POWER TRANSACTION APPARATUS
6: SETTLING SYSTEM
11A, 11B: STORAGE STATE DETECTING UNIT
12A, 12B: TEMPERATURE DETECTING UNIT
13A, 13B, 13C: TIME COUNTING UNIT
14A: FIRST ELECTRIC POWER INFORMATION STORING UNIT
14B: SECOND ELECTRIC POWER INFORMATION STORING UNIT
14C: ELECTRIC POWER INFORMATION STORING UNIT
15A, 15B, 15C: ELECTRIC POWER INFORMATION CONTROL UNIT
16A, 16B, 16C: STORAGE BATTERY CHARACTERISTIC CORRECTING UNIT
17A, 17B, 17C: TEMPERATURE CHARACTERISTIC CORRECTING UNIT
18A, 18B, 18C: SELF-DISCHARGING CORRECTING UNIT
19A, 19B, 19C: CHARGING AND DISCHARGING COUNT MANAGING UNIT
22A, 22B, 22C: COMMUNICATION UNIT
23A, 23B, 23C: ACCOUNT SETTLEMENT UNIT
71, 81: THIRD ELECTRIC-POWER TRANSACTION APPARATUS
75: SOLAR POWER GENERATING APPARATUS
80: COMMUNICATION LINE
100: ELECTRIC VEHICLE

1-10. (canceled)

11. An electric-power transaction apparatus comprising:
a first electric power information obtaining unit configured to obtain information from a first electric power information storing unit configured to store first electric power information comprising an amount of electric power stored in a first storage battery and first electric power value information which is information relating to a value of the first electric power amount;
a second electric power information obtaining unit configured to obtain information from a second electric power information storing unit configured to store second electric power information comprising an amount of electric power stored in a second storage battery and electric power value information of the electric power amount; and
an electric power information control unit configured to perform electric power transaction between the first storage battery and the second storage battery based on the first electric power information and the second electric power information,
wherein the electric power information control unit compares the electric power value information relating to a specific electric power amount of the electric power amount of the first storage battery and the electric power value information relating to the specific electric power amount of the electric power amount of the second storage battery, and swaps and stores, when there are the electric power information in which the electric power value information relating to the specific electric power amount are different from each other in both the storage batteries, the electric power value information in the first electric power information storing unit and the second electric power information storing unit.

12. The electric-power transaction apparatus according to claim 11,
wherein the electric power value information comprises a power generation method or an electric power price for the amount of electric power stored in each of the storage batteries.

13. The electric-power transaction apparatus according to claim 11,
wherein the electric power information control unit divides the first electric power information into a plurality of pieces of electric power information to compare the electric power value information relating to the specific electric power amount between the electric power amount of the first storage battery and the electric power amount of the second storage battery.

14. The electric-power transaction apparatus according to claim 11, further comprising:
a storage state detecting unit configured to detect a storage state of the first storage battery,
wherein the electric power information control unit compares, when the storage state detecting unit determines that the discharging speed of the first storage battery is a predetermined value or lower, the electric power value information relating to the specific electric power amount.

15. The electric-power transaction apparatus according to claim 14,
wherein the electric power information control unit re-measures the amount of electric power stored in the first storage battery by the storage state detecting unit before comparing the electric power value information relating to the specific electric power amount, and updates and stores the first electric power information in the first electric power information storing unit.

16. The electric-power transaction apparatus according to claim 11, further comprising:
a storage battery characteristic correcting unit in which the storage characteristics of the first storage battery are stored,
wherein the electric power information control unit corrects the amount of electric power stored in the first storage battery by the storage battery characteristic correcting unit before comparing the electric power value information relating to the specific electric power amount, and updates the first electric power information to perform the electric power transaction.

17. The electric-power transaction apparatus according to claim 16,
wherein the first electric power information comprises information relating to a temperature of the first storage battery measured when the amount of electric power stored in the first storage battery is measured,
wherein the storage battery characteristic correcting unit comprises a temperature characteristics correcting unit in which characteristics of the storage amount and temperature of the first storage battery are stored, and
wherein the electric power information control unit corrects the amount of electric power stored in the first storage battery based on the measured temperature and temperature at the electric power transaction by the temperature characteristics correcting unit before comparing the electric power value information relating to the specific electric power amount, and updates the first electric power information to perform the electric power transaction.

18. The electric-power transaction apparatus according to claim 17,
wherein the first electric power information comprises information relating to a time measured when the amount of electric power stored in the first storage battery is measured,
wherein the storage battery characteristic correcting unit comprises a self-discharging characteristic correcting unit in which characteristics of the storage amount and elapsed time of the first storage battery are stored, and
wherein the electric power information control unit corrects the amount of electric power stored in the first storage battery based on the measured time and a time at the electric power transaction by the self-discharging characteristic correcting unit before comparing the electric power value information relating to the specific electric power amount, and updates the first electric power information to perform the electric power transaction.

19. A method of controlling an electric-power transaction apparatus, said method comprising:
obtaining information from a first electric power information storing unit configured to store first electric power information comprising an amount of electric power stored in a first storage battery and electric power value information which is information relating to a value of the electric power amount;
obtaining information from a second electric power information storing unit configured to store second electric power information comprising an amount of electric power stored in a second storage battery and electric power value information of the electric power amount; and
performing electric power transaction between the first storage battery and the second storage battery based on the first electric power information and the second electric power information,
wherein the electric power transaction comprises comparing the electric power value information relating to a specific electric power amount of the electric power amount of the first storage battery and the electric power value information relating to the specific electric power amount of the electric power amount of the second storage battery, and swapping and storing, when there are the electric power information in which the electric power value information relating to the specific electric power amount are different from each other in both the storage batteries, the electric power value information in the first electric power information storing unit and the second electric power information storing unit.

20. A computer readable medium having a program stored thereon and readable by a computer, said program, when executed by the computer, causing the computer to execute the method of controlling the electric-power transaction apparatus according to claim 19.
